(19) United States
(12) Patent Application Publication
(10) Pub. No.: US 2015/0109457 A1
(43) Pub. Date: Apr. 23, 2015

(54) MULTIPLE MEANS OF FRAMING A SUBJECT

(71) Applicant: JIGABOT, LLC, Highland, UT (US)

(72) Inventors: Richard F. Stout, Highland, UT (US); Kyle K. Johnson, Eagle Mountain, UT (US); Kevin J. Shelley, Salt Lake City, UT (US); Donna M. Root, American Fork, UT (US)

(21) Appl. No.: 14/589,427

(22) Filed: Jan. 5, 2015

Related U.S. Application Data
(63) Continuation-in-part of application No. 14/045,445, filed on Oct. 3, 2013.
Application No. 14/045,445 is a continuation-in-part of application No. 14/502,156, filed on Sep. 30, 2014.
(60) Provisional application No. 61/744,846, filed on Oct. 4, 2012.
(60) Provisional application No. 61/964,475, filed on Jan. 6, 2014.
(60) Provisional application No. 61/964,474, filed on Jan. 6, 2014.
(60) Provisional application No. 61/964,481, filed on Jan. 6, 2014.
(60) Provisional application No. 61/964,483, filed on Jan. 6, 2014.
(60) Provisional application No. 61/965,048, filed on Jan. 18, 2014.
(60) Provisional application No. 61/965,939, filed on Feb. 10, 2014.
(60) Provisional application No. 61/965,967, filed on Feb. 10, 2014.
(60) Provisional application No. 61/965,940, filed on Feb. 10, 2014.
(60) Provisional application No. 61/965,967, filed on Feb. 10, 2014.
(60) Provisional application No. 61/965,444, filed on Jan. 30, 2014.
(60) Provisional application No. 61/965,048, filed on Jan. 18, 2014.

(51) Int. Cl. G01S 3/786

(52) U.S. Cl. CPC G01S 3/7864
USPC 348/169

(57) ABSTRACT

A system for tracking a cinematography target can comprise an emitter configured to attach to a target and to emit a tracking signal. A tracker can be configured to receive the tracking signal from the emitter and to track the emitter based upon the received tracking signal. The tracker can comprise a control module configured to identify a location of the target and to position an audiovisual device to align with a target. Additionally, the tracker can comprise a script execution processor configured to execute a user selected script. The user selected script may be selected from a set of respectively unique scripts. The user selected script can determine one or more control module movements specific to tracking the emitter.

### CROSS-REFERENCE TO RELATED APPLICATIONS

This application claims priority to U.S. Provisional Patent Application Ser. No. 61/964,475 filed on Jan. 6, 2014, entitled “USER DEFINABLE ACTIVITY SCRIPTS IN A TRACKING SYSTEM,” and to U.S. Provisional Patent Application Ser. No. 61/964,474 filed on Jan. 6, 2014, entitled “BIASING CURVES IN A TRACKING SYSTEM,” and to U.S. Provisional Patent Application Ser. No. 61/964,481 filed on Jan. 6, 2014, entitled “INTEGRATING METHODS FOR ENHANCED FUNCTIONING OF A TRACKING SYSTEM,” and to U.S. Provisional Patent Application Ser. No. 61/964,483 filed on Jan. 6, 2014, entitled “3D VISION AND TRACKING WITHIN A TRACKING SYSTEM,” and to U.S. Provisional Patent Application Ser. No. 61/965,048 filed on Jan. 18, 2014, entitled “INTEGRATING NATIVE VIDEO WITHIN A TRACKING SYSTEM,” and to U.S. Provisional Patent Application Ser. No. 61/965,939 filed on Feb. 10, 2014, entitled “DISCONTINUOUS PULSING OF SIGNALS,” and to U.S. Provisional Patent Application Ser. No. 61/965,967 filed on Feb. 10, 2014, entitled “3D AND FACIAL TRACKING,” and to U.S. Provisional Patent Application Ser. No. 61/965,940 filed on Feb. 10, 2014, entitled “3RD AXIS ROTATION TRACKING DEVICE,” and a continuation-in-part of U.S. patent application Ser. No. 14/045,445 filed on Oct. 3, 2013, entitled “COMPACT, RUGGED, INTELLIGENT TRACKING APPARATUS AND METHOD,” which claims priority to U.S. Provisional Patent Application Ser. No. 61/744,846 filed on Oct. 4, 2012, entitled “COMPACT, RUGGED, INTELLIGENT TRACKING APPARATUS AND METHOD.” Additionally, this application is a continuation-in-part of U.S. patent application Ser. No. 14/502,156 filed on Sep. 30, 2014, entitled “SYSTEM FOR AUTOMATICALLY TRACKING A TARGET,” which claims priority to U.S. Provisional Patent Application Ser. No. 61/965,967 filed on Feb. 10, 2014, entitled “3D AND FACIAL TRACKING,” and to U.S. Provisional Patent Application Ser. No. 61/965,444 filed on Jan. 30, 2014, entitled “GRID & ANGULAR DATA TRACKING WITHIN A TRACKING SYSTEM,” and to U.S. Provisional Patent Application Ser. No. 61/965,048 filed on Jan. 18, 2014, entitled “INTEGRATING NATIVE VIDEO WITHIN A TRACKING SYSTEM.”

All the aforementioned applications are incorporated by reference herein in their entirety.

### BACKGROUND OF THE INVENTION

One reason that video and film production is difficult or expensive, is because it requires skilled labor: people who can operate cameras, lights, microphones, or similar devices with skill. Cameras, lights, microphones, and other equipment will, at various times, be hand held, or otherwise operated by trained individuals (for best effect), while actors, athletes, or other subjects are being filmed, lit, and recorded.

Recently, with the market arrival of low cost, high quality digital recorders, many non-professional and professional consumers have increasingly used recorders to document a variety of different events. For example, many consumers create films of themselves or others performing extreme sports, such as rock climbing, skydiving, motor cross, mountain biking, etc. Similarly, consumers are able to create High Definition quality films of family events, such as reunions, sporting events, graduations, etc. Additionally, digital video recorders have also become more prevalent in professional and industrial settings. For example, law enforcement departments have incorporated video recorders into police cruisers.

While recent advances in film and video creation and production have allowed consumers and professionals to easily create high quality videos of various events, it can still be difficult for consumers and professionals to acquire the quality and perspective that they may desire in their footage. For example, smoothly operating a camera—panning and tilting it—as a subject moves about in front of it—is difficult even for professionals. Additionally, an individual may desire to record him- or herself snowboarding down a particular slope. One will understand the difficulty the individual would have in simultaneously filming themselves from a third person perspective, such as when they are skiing past a camera that is being swiveled on a tripod by an operator to keep them “in frame.” Similarly, a police officer may desire to record their interactions with the public, but a dash-mounted recorder only provides a limited and static field of view.

Accordingly, there is a need for systems, methods, and apparatus that can gather video footage of desired events and individuals without requiring direct and continual user interaction with the recording device.

### BRIEF SUMMARY OF THE INVENTION

Implementations of the present invention comprise systems, methods, and apparatus configured to track a cinematography target based upon various user commands and various automatic customizations. In particular, implementations of the present invention comprise executable scripts that allow a user to customize the particular actions of the tracking device. For example, a user can specify that the tracking device track a face that is associated with a particular cinematography target. Additionally, a user can specify under what conditions a tracker should begin to track a target, how the trucker should track, and what the tracker should do during the tracking.

Implementations of the present invention comprise a system for tracking a cinematography target can comprise an emitter configured to attach to a target and to emit a tracking signal. The emitter can comprise an output module configured to emit the tracking signal. A tracker can be configured to receive the tracking signal from the emitter and to track the emitter based upon the received tracking signal. The tracker can comprise a receiver module configured to receive the tracking signal and to identify the one or more identifiable signals. Additionally, the tracker can comprise a control module configured to identify a location of the target and to position an audiovisual device to align with a target. Further, the tracker can comprise a script execution processor configured to execute a user selected script. The user selected script may be selected from a set of respectively unique scripts. The user selected script can determine one or more control module movements specific to tracking the emitter. Additionally, a user interface device can be configured to receive commands from a user and communicate the commands to the tracker.

An additional implementation of the present invention can comprise a computer-implemented method at a tracking device for tracking a cinematography target that has been associated with an emitter. The method can include receiving at the tracking device an indication to track a particular identifier. The particular identifier can be associated with the cinematography target. The method can also include identifying, using at least one tracker component, at least a direction associated with an origination point of an occurrence of the particular identifier. Additionally, the method can include executing a user selected script that is selected from a set of respectively unique scripts. The user selected script can determine one or more tracking movement attributes specific to tracking the emitter. Further, the method can include calculating, based upon the user selected script and the indication of at least a direction associated with an origination point of an occurrence of the particular tracking signal, a motor actuation sequence necessary to actuate a control component to track the object of interest in accordance with the user selected script. Further, still the method can include actuating at least one motor to track the object of interest in accordance with the calculated motor actuation sequence.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a diagram of an implementations of a tracking system showing some of elements including a tracking device, an emitter, a subject, a mounted device, a UI device, as well as mounting devices and stands (sometimes called by cinematographers “grip devices”) for some of these;

FIG. 2 depicts a detailed block diagram of an implementation of a tracking system showing at least some of its devices, systems and subsystems;

FIG. 3 depicts a subject or tracking object being framed within a video viewfinder or view;

FIG. 4 depicts a block diagram showing implementations of components of an activity script;

FIG. 5A depicts a flow chart for an implementation of a method used to share an activity script between different tracking devices;

FIG. 5B depicts a block diagram of an implementation of an activity process, consisting of one or more activity scripts that are linked together in a causative manner;

FIG. 6 depicts two perspectives that might be used by an implementation of a User Interface device to define a path in which an emitter or subject may travel;

FIG. 7 depicts a block diagram of an implementation of a method for integrating data for color & shape recognition and validation, and for integrating the results in order to improve tracking and positioning;

FIG. 8 depicts a stylized illustration of an implementation for a tracking object and two emitters and a tracking device and an attached camera;

FIG. 9 depicts a schematic diagram of an implementation of two camera modules found within a sensory subsystem of a tracker;

FIG. 10 depicts a flowchart of an implementation of a method for both tracking and recording video with or without a mounted camera device;

FIG. 11 depicts a flowchart of an implementation of a method for passing actuation data to a motor-positioning subsystem;

FIG. 12A depicts a block diagram of an implementation of a tracking device;

FIG. 12B depicts another block diagram of an implementation of a tracking device;

FIG. 13A depicts another block diagram of an embodiment of a tracking device;

FIG. 13B depicts another block diagram of an embodiment of a tracking device; and

FIG. 14 depicts a flowchart for an implementation of a method for adjusting one or more actuators.

### DETAILED DESCRIPTION OF THE PREFERRED EMBODIMENTS

The present invention extends to systems, methods, and apparatus configured to track a cinematography target based upon various user commands and various automatic customizations. In particular, implementations of the present invention comprise executable scripts that allow a user to customize the particular actions of the tracking device. For example, a user can specify that the tracking device track a face that is associated with a particular cinematography target. Additionally, a user can specify under what conditions a tracker should begin to track a target, how the trucker should track, and what the tracker should do during the tracking.

One of the needs anticipated by this invention is the need for a user to be able to “script” an activity to be performed by a tracker or emitter or mounted device (or yet other elements of the tracking system) such that (1) activity start conditions, device actions, configurations to be used by devices, and activity ending conditions can be defined; and (2) that such defined scripts might be moved to and implemented by one or more specified tracking devices and/or emitters and/or mounted devices (and other elements of the tracking system).

Another need anticipated of a tracking system is the need to achieve specific framing effects that may be aesthetically pleasing. For example, a user may want a tracker (via configuration or defaulted behaviors) to “frame” the tracking object or part of the tracking object (such as the face) in a particular manner. One common way that shooters of video like to frame, is by “leading the action,” where the camera “anticipates” where the tracking object is going and then showing the tracking object in the “back” of the screen and showing “where they are about to be” in the front of the screen. Similarly there are many other ways in which a tracking object may be framed in some biased manner in order to achieve an artistic effect, such as by centering the eyes of a subject on specific cross hairs (offset from center) of a viewfinder or video frame.

In various implementations, a tracking system may be used to aim at a subject while a mounted camera records video. Additionally, in at least one implementations, a tracking system may itself contain a sensory subsystem capable of recording and storing video (as well as aiming at a subject). Accordingly, if a tracking system can both automatically track a subject and record video simultaneously (which could be viewed and otherwise used or enjoyed)—without the need of an attached camera or mounted camera—then particular benefits would be clear to a user. In particular, the benefits would include less equipment to carry around, shorter setup time, convenience, redundant video coverage in the event that the mounted camera's video is not good or is not sufficient. Additionally, implementations of the present invention have implications for ways of framing a subject.

In at least one implementation, a tracking device may function in part by aiming at an emitter. For example, the emitter may emit a particular wavelength of light, such as IR light (or other light). When the tracking device senses that light within a sensory subsystem, the tracking device can track the light by tilting and swiveling and alternatively rotating on a 3rd axis of rotation. As such, the tracking device can track an object by tracking an emitting device that is attached to the object.

In at least one implementation, the tracking device can track a continuous emission of IR light, in an uninterrupted line-of-sight orientation between the emitter and the tracker. In contrast, however, a pulsing signal of light may provide significant benefits. For example, (1) pulsing of some kinds of light may result in temporarily brighter light pulses, and thus be more easily sensed; (2) emitters may be visible at further distances; (3) pulsing light may be easier to differentiate from ambient IR light that may exist in the same scene or space where the tracking activity is occurring.

A tracking system can follow a person or other object (tracking object) but it may be desirable to track a specific part of the tracking object, such as the face of a person, or the face of a person as the tracking object moves nearer or further away from the tracker and attached camera. In at least one implementation, by combining various sensors or receivers available to a tracking device, including the use of two cameras in order to have image-sensor data provision parallax information, a tracking object can be tracked more accurately and enable distance data to be included. Possible benefits include the following: tracking can be made more accurate; framing of a tracking object can be properly adjusted at different distances from the tracker; one camera may at times track while the other camera simply records video; both cameras may record video (3D video) while tracking is being done simultaneously; one camera system may be used for IR tracking, while the other used for video shooting; with more data, tracking may be more smooth, and more sensitive to user configurations; with more data, system pattern recognition and integration may be more effective.

Further, in at least one implementation, a tracking system may tilt and swivel with predetermined movements in order to aim at a tracking object or emitter. For example, at times the video from such a tracking device may be at an odd or “Dutch Angle” as it is called commonly in the field of cinematography. A Dutch Angle may be thought of as the video frame when the camera is tilted so as not to be parallel with the ground plane.

At times a “Dutch Angle” is desirable as when an attached video camera device is recording video, and the cinematographer wants the clip to give the viewer a sense of being off balance or “off kilter.” But often, the Dutch Angle is not desirable, as when the video frame is supposed to be level with the ground plane of the scene—as is typical in most cinematic shots. In at least one implementation, a tracker is capable of tilting vertically, and swiveling horizontally, and also of creating or removing a Dutch Angle through the use of rotating on a 3rd axis.

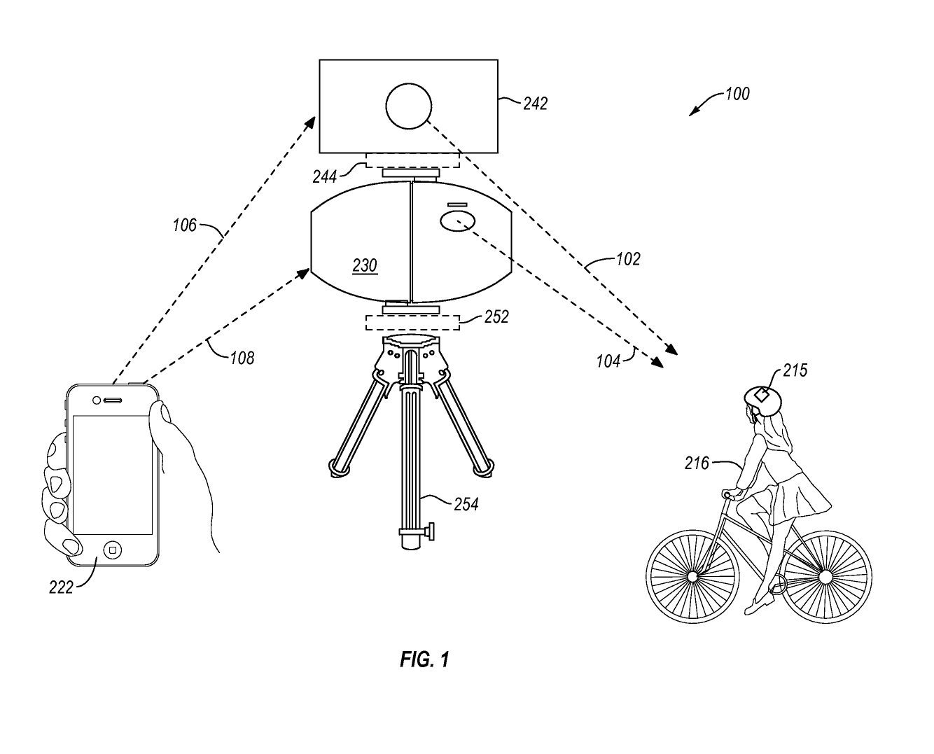

FIG. 1 is an illustration 100 of a non-limiting embodiment of the present invention representing some ways in which the invention may be used. A tracking device 230, which may be called a tracker 230, sits below a mounted device 242, which may be a video camera 242, a light, a microphone, or some other cinematic device. The tracker 230 and the camera 242 are joined via an attachment adapter 244, which serves to tilt and swivel and aim the camera 242, or other mounted device, as the tracker 230 itself tilts and swivels and aims at a tracking object 216 which may be a person or other object.

The mounted camera 242, or other mounted device, may thus face directly toward the tracking object 216, as illustrated by arrow 102. This may be facilitated because the tracker 230 may also be facing directly towards the tracking object 216, as illustrated by arrow 104. The facing direction 104 of the tracker 230 is made possible because the tracker 230 sees or otherwise senses the tracking object 216, which may have an attached emitter 215 or beacon, performs various activities (including sensory and control and positioning activities) in order to affect its aiming 104 at the tracking object 216.

Thus as the tracking object 216 moves about, the tracker 230 aims 104 at it, and the mounted device 242 aims 102 at the tracking object 216 as well. If the mounted device 242 is a camera and is recording a video, the tracking object 216 is thus kept “in frame” and recorded. Because the tracking device 230 can tilt and swivel, it can aim 104 at the tracking object 216 moving in any direction within 3D space (which may include up or down or left or right, or towards or away from the tracking device 230).

The tracking device 230 can be attached via another mount 252 or grip adapter, to a grip device 254 such as a tripod or any number of other devices. The mount or adapter 252 may be especially designed to couple both with the tracker 230 and a particular grip device 254 such as a particular tripod or dolly or bike or helmet or drone/quad-copter and so on. Thus the tracker 230 may be attached to a grip device 254, which may be stationary or moving in any direction of 3D space, such as would be the case if the grip device 254 were a flying drone. Whether the grip device 254 is static or moving, or the tracking object 216 is static or moving, the tracker 230 may aim 104 at the tracking object 216 and the attached mounted device 242 may aim 102 at the tracking object 216.

Additionally, in at least one implementation, a UI device 222, such as a smartphone or tablet or computer or other device, may be capable either directly or indirectly of configuring or controlling or exchanging data with or being controlled by or being configured by (or of performing some other useful interactions with) the tracker 230 and/or the mounted device 242 and/or the grip device and/or the emitter 215. The UI device 222 might enable a user to gain added benefit from his or her tracker 230 or mounted device 242 or grip device 254 or emitter 215. For example, a user may, via a UI device 222, create a “script” that “tells” the tracker 230 to run in a particular way, under certain circumstances.

In at least one implementation, the UI device 222 may be used to configure one or more trackers 230 and/or mounted devices 242 and/or grip devices 254 and/or emitters 215, or to configure one or more of these to communicate with or otherwise affect one or more of the other of these trackers 230 and/or mounted devices 242 and/or grip devices and/or emitters 215. Additionally, the tracker 230 and other devices and systems of illustration 100 may not be required to be connected with UI device 222 in order to provide beneficial use and functionality. In particular, in at least one implementation, the functionality performed by the UI device 222 may also be provided by a user interface integrated into one or more trackers 230 and/or mounted devices 242 and/or grip devices and/or emitters 215.

Accordingly, in at least one embodiment, if a person wants to record themselves from a third-party perspective, with a mounted device 242 (which may be a video camera), while they are moving around, they may do so with the present invention by mounting it via the attachment adapter 244 to the tracking device 230. Nevertheless, there may be many other unique and valuable uses of the invention which have not been specifically enumerated herein, but which are facilitated, and intended by the current invention. For example, it can be readily understood that the mounted device 242 may represent a light or microphone which can be mounted, via another attachment adapter 244 to the tracking device 230, and thus be automatically aimed at a tracking object 216, which one wishes to illuminate or record audio from, without continuous user intervention. As such, implementations of the tracking system 200 perform a unique function and provide clear value.

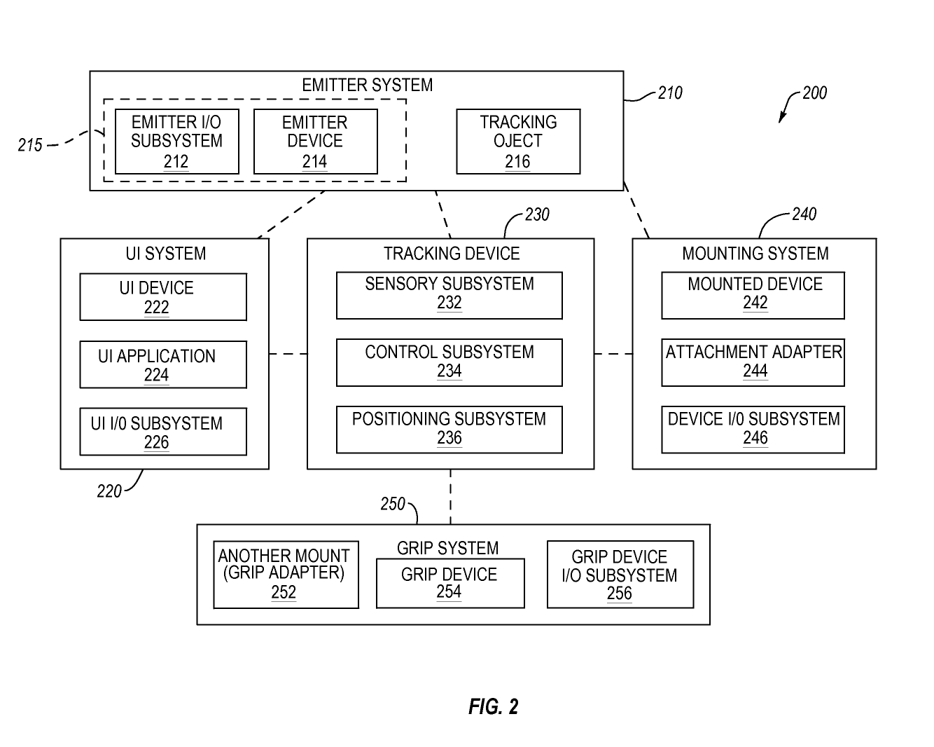

FIG. 2 is an illustration of an implementation of a tracking system or apparatus 200. In at least one implementation, the tracking system 200 may include one or more emitter systems 210 (in whole or part), which are followed or tracked by one or more tracking devices 230 (or “trackers”). The tracking devices 230 may be mounted to one or more mounting systems 240 or grip systems 250. The tracking systems may be configured or automated and otherwise controlled by one or more user interface (UI) systems 220, as may other subsystems (210, 240, or 250) of tracking system 200.

The emitter system 210 may comprise an emitter I/O subsystem 212 and one or more emitter devices 214. The emitter devices 214 may be attached to a person (or persons) or other object (or objects) 216. The emitter I/O subsystem 212 together with the emitter device 214 is sometimes referred to as “the emitter” 215, and may comprise a single device, at least in a preferred embodiment. The emitter 215 may also be a device that has only an emitter I/O subsystem 212 or emitter device 214.

In at least one embodiment, the emitter I/O subsystem 212 is connected with the emitter device 214, and may include RAM, a processor, a Wi-Fi transceiver, a power source, and so on. In various implementations that components and modules of the emitter I/O subsystem 212 are all effective to enable the emitter device 214 to be configured and otherwise controlled directly or from the UI system 220. For example, the emitter I/O subsystem 212 can configure to the emitter system 210 to pulse according to a unique and pre-configured or use-selectable/configurable pulse rate or modulation mode, and to communicate with the tracking device 230 via a transceiver in both the emitter 215 and the tracker 230.

Via the emitter I/O subsystem 212, one or more emitters 215 may be turned on or off, may begin or stop emitting or signaling, may be modulated or pulsed or otherwise controlled in such a way as to be uniquely distinguishably by the tracking device 230. The emitter I/O subsystem 212 may also receive signals from or send signals to an emitter device 214, or the UI system 220, or the tracking device 230, and the mounting system 240 directly or via one or more tracking devices 230 or UI systems 220, or the grip system 250.

The emitter device 214 can be a type of infrared light emitter (such an LED), a supersonic audio emitter, a heat emitter, a radio signal transmitter (including Wi-Fi and bluetooth), or some other similar emitter device or system or subsystem. Additionally, the emitter 215 can be an inactive system such as a reflective surface from which a color of shape can be discerned by the sensory subsystem 232. In at least one embodiment, one or more emitter devices 214 modulate, pulse, or otherwise control emitted signals or light (visible or non-visible, such as infrared), or sounds, or thermal radiation, or radio transmissions, or other kinds of waves or packets or bundles or emissions, in order to be discernible to a tracking device 230. The tracking device 230 may communicate with the emitter device 215 via the UI system 220, or the emitter I/O subsystem 212 or both, in order to enhance, clarify, or modify such emissions and communications from one or more emitter devices 214.

In at least one embodiment, the emitter devices 214, may be embedded within clothing (such as sport team jerseys, ski jackets, production wardrobe, arm bands, head bands, etc.), equipment (such as football helmets, cleats, hang gliders, surfboards, etc.), props (glasses, pens, phones, etc.), and the like, in order to “hide” the emitter device 215 from being obviously visible to spectators. For example, small emitter devices 215 can be hidden beneath a logo, or integrated with a logo, so as to not be prominently visible. In contrast, fashion accessories, such as hats, shirts, shorts, jackets, vests, helmets, watches, glasses, may be fitted with emitter devices 214, such that the device may be visible and obvious, and acceptably so, for its “status symbol” value. To allow for a small emitter device 214 size, micro batteries and other power sources may be used to power the emitter devices 214.

Tracking objects 216, such as people, animals, moving, or objects (e.g., cars or balls), may all be fitted with emitter devices 214, but need not be in order to be trackable by tracking device 230 within system 200. As stated above, the emitter devices 214 can be embedded in clothing being worn, props being carried, equipment being used, or fashion accessories being worn. As such, at least one embodiment allows for a tracking object 216 to effectively signal or emit its presence, as it moves about.

In at least one implementation, the typical or expected ways in which a tracking object 216 does move about may be known to the UI system 220, via user configuration or input and embedded system algorithms or software. Thus, as the tracking object 216 moves about, the tracking device 230 can tilt or swivel, or move in 3D space, in order to follow and track the tracking object 216, according to a user's preferences or predefined activity configurations or programmed scripts. As the tracking device 230 thus tracks the tracking object 216, the mounted system 240 and device 242 (be it a camera, light, or microphone), also follows the tracking object 216 in synchronous motion as well as in ways and patterns “predicted” in part by what that the user configures or programs.

The UI system 220 can include a user interface device 222 (such as a smartphone or other computer 12 device), a user interface application (“app”) 224, and a user interface I/O subsystem 226, which enables the UI system to communicate to and from other systems 200 and other devices 210, 220, 230, and 240 within the tracking system 200. In at least one embodiment, the user interface device 222 runs the user interface app 224 and communicates through the user interface I/O subsystem 226, which is typically embedded within and is a part of the user interface device 222. The user interface device 222 provides users with a user interface app 226 that provides an interface to configure one or more emitter devices 214, tracking devices 230, and/or mounted devices 242, and to automate activities within the tracking system 200 via scripts, which are illustrated later. The user interface application 224 may also be programmed to perform other features of sensory input and analysis beneficial to some other system 200, as well as to receiving user tactile input and communicating with the tracking device 230 or the mounting system 240 of the immediate system 200.

Additionally, in at least one embodiment, the user interface app 224 may also allow a user to specifying from a list the kind of activity that a tracking object 216 is participating in (jumping on a trampoline, walking in circles, skiing down a mountain, etc.). In at least one embodiment, the list can be revised and expanded to include additional activities defined by a user or downloaded to the user interface app 224.

The user interface app 224 may additionally allow users to diagram the activities expected by the tracking object 216, define an X and Y grid offset for the tracking of the emitter device 214 by the tracking device 230, specify an offset by which the user wants the action to be “led” or “followed,” etc. (if tracking other than just by centering of the emitter device 214 by the tracking device 230). For example, the tracking device 230 may generally follow the emitter device 214 by biasing the centering of the tracking object 216 in some manner pleasing to the user.

Additionally, the user interface app 224 may additionally enable interpretation, change, or control of the identification signal (or emitted, modulated signal) or the emitter device 214. It may also manage and enable the user interface device 222, and the user interface I/O subsystem 226, to accomplish tasks and processes and methods identified later as useful for other interconnected systems 200.

The user interface app 224 may additionally enable updating of one or more UI devices 222, tracking devices 230, mounting systems 240, emitter systems 210, or other computers connected to the tracking system 200. Additionally, the user interface app 224 may provide for execution of unique and novel formulas or algorithms or scripts or configuration data, enabling improved functioning of the tracking device 230 or other systems within the tracking system 200. For example, a user may be able to download a particular script that is directed towards tracking basketball players or a script that is directed towards tracking scuba divers. Accordingly, at least one embodiment of the present invention provides significant flexibility in tracking a variety of different activities.

Turning now to the tracking device 230, the tracking device 230 may include one or more sensory subsystems 232, control subsystems 234, and positioning subsystems 236. The sensory subsystem 232 may be comprised of one or more sensors or receivers including infrared, RF, ultrasonic, photographic, sonar, thermal, image sensors, gyroscopes, digital compasses, accelerometers, etc. In at least one embodiment, the sensory subsystem 232 includes an image sensor that reacts to infrared light that is emitted by one or more emitter devices 214. The sensory subsystem 232 may be designed specifically to identify more than one emitter device 214 simultaneously. The sensory subsystem 232 may be capable of identifying multiple emitter devices 214 that are of the same signal or modulation or pulse rate, or of different signals or modulations or pulse rates.

In at least one embodiment, if multiple emitter devices 214 are of the same signal, modulation, or pulse rate, they may be perceived by the sensory subsystem 232 as a single light source (by means of a weighted average of each, or by some other means), although in fact they may combine to represent a single “point cloud” with multiple, similar signals, modulations, or pulse rates. Similarly, in at least one implementation, if multiple emitter devices 214 are of different signals, modulations, or pulse rates, they may be perceived by the sensory subsystem 232 as distinct from each other—creating in effect, multiple light sources within the perception of the sensory subsystem 232. Each light source perceived by the sensory subsystem 232 may be converted to an X and Y position on a two-dimensional grid, as in a cartesian coordinate system, by the sensory subsystem 232 and/or control subsystem 234. In at least one implementation, each light source can be positioned within a three-dimensional grid, comprising X, Y, and Z coordinates based upon relative position and distance from the tracking device 230.

The two dimensional grid may be understood as an image sensor onto which light is focused by lenses, as in a camera system, of which the sensory subsystem 232 may be a kind. The image sensor may be a two-dimensional plane, which is divided by units of measurement X in its horizontal axis, and Y on its vertical axis, thus becoming a kind of measurement grid.

Several times per second (perhaps 24, 30, or 60 or a particular video frame rate), the location of each unique emitter device 214 (based upon a unique signal or modulation, or pulse rate, or perhaps some other identifiable marker), or of each “point cloud” represented by a group of similar emitter devices 214 (based upon a unique signal or modulation, or pulse rate, or perhaps some other identifiable marker), may be given an X and Y coordinate representation, which may be represented as two integer numbers.

In at least one embodiment, the tracking device 230 uses the X and Y coordinate data to calculate (via the control subsystem 234) a distance from a center X and Y position, in order to then position tilt- and swivel-motors via a positioning subsystem 236 to “center” (or bias-center) the emitter device 214 within its two-dimensional grid. The net effect is that the tracking device 230 tilts and swivels until “facing” the emitter device 214, or emitter device 214 “point cloud.”

Additionally, in at least one embodiment, several times per second the tracking device 230, identifies an X and Y coordinate for each emitter device 214, or “point cloud” of emitter devices 214. These X and Y coordinates may be saved as a history of coordinates (perhaps appended to a data array unique to each emitter device 214 or emitter device 214 cloud) by the control subsystem 234. Over time, these data arrays represent a history of travel of the emitter device 214 or cloud. These data arrays can then analyzed by a control subsystem 234, possibly based upon configuration data that may come from the UI system 220, in order to “fit” their data history into mathematical curves or vectors that approximate the array data history of travel, and also “predict” X and Y coordinates of future travel. In this manner (and in similar ways) the tracking device 230 may thus obtain and analyze data whereby it might “learn” how to better track the tracking object 216 and the emitter device 214 over time or in similar situations in the future.

Accordingly, in at least one implementation, the control subsystem 234 may control a positioning subsystem 236, and its tilt and swivel motors, in a partly “predictive” manner, that “faces” the tracking device 230 at the current or predicted location of the emitter device 214 or cloud over time. This may be particularly useful in cases where the emitter device 214 is partly or fully obscured for at least a period of time. The net effect of a “learning” and “predictive” tracking capability may yield a more “responsive” and “smooth” tracking activity than would be the case with the simple embodiment or tracking/centering approach alone. The control system 234 may employ other unique and novel mechanisms to smooth the tilt and swivel motors of the positioning subsystem 236 as well, including using unique mathematical formulas and other data gathered via I/O subsystems 246, 226, 212 or those of other tracking systems 200. Triangulation of emitter devices 214 and related tracking device 230 control may thus be enabled.

In at least one implementation, the positioning subsystem 236 responds to controls from the control subsystem 234 to control servo motors or other motors, in order to drive rotation of the device on a tilt axis, rotation on a swivel axis, and perhaps rotation on a third axis as well.

Additionally, in at least one implementation, the mounting system 240 includes a mounted device 242 (such as a light, camera, microphone, etc.), an attachment adapter 244 (which enables different devices to be adapted for mounting quickly and easily), and a device I/O subsystem 246. In at least one embodiment, the device I/O subsystem 246 enables communication and control of the mounted device 242 via a tracking device 230, UI system 220, or emitter I/O subsystem 212, or some combination of these, including other systems and subsystems of other tracking systems 200. Data from the mounted device 242 may also be provided to the tracking device 230, the UI system 220, and/or the emitter system 210 in order that system 200 performance may be improved thereby in part.

The mounted device 242 may be affixed via the attachment adapter 244 to the tracking device 230, such that the mounted device 242 may be tilted or swiveled in parallel with the tracking device 230, thus always facing the same direction as the tracking device 230. Additionally, the mounted device 242 may be controlled via the device I/O subsystem 246 (and perhaps also via the UI system 220 or the tracking device 230), in order to operate the mounted device 242 simultaneous to the mounted device 242 being positioned by the tracking device 230.

The tracking device 230 is sometimes referred to simply as “tracker.” An emitter device 214 is sometimes referred to as simply as “emitter.” The emitter I/O subsystem 212 may be called an “emitter,” the subsystem 212 with the emitter device 214 together or collectively are sometimes called “the emitter” 215. The user interface device 222 is sometimes referred to as simply the “user interface.” The sensory subsystem 232 is sometimes referred to as “detector.” The control subsystem 234 is sometimes referred to as “controller.” The positioning subsystem 234 is sometimes referred to as “positioner.” The device I/O subsystem 246 is sometimes called the “mount I/O system.” The mounting system 240 is sometimes called a “mount system.” The attachment adapter 244 is sometimes called an “adapter.”

Processes associated with system 100 and system 200 include, but are not limited to, the following: making decisions about whether or not to track; knowing what algorithms to use for tracking of an emitter or tracking object; sensing of an emitter by a tracker; sensing of a tracking object by a tracker; plotting the position of an emitter or tracking object within a space or coordinate system of the tracker; saving history of plotting or sensing or motor encoder, or other information; configuring which emitter or emitters or tracking object or tracking objects to track and under what circumstances to aim or follow or track; predicting where one or more emitters or tracking objects may be going in the future; smoothing the predicted path of the emitters or tracking objects or motors moving to aim at emitters or tracking objects, all in accordance with knowing and configuring data; positioning of the motors (while optionally using encoder information from the motors) via rotating them in positive or negative amounts or degrees or encoder “ticks.”

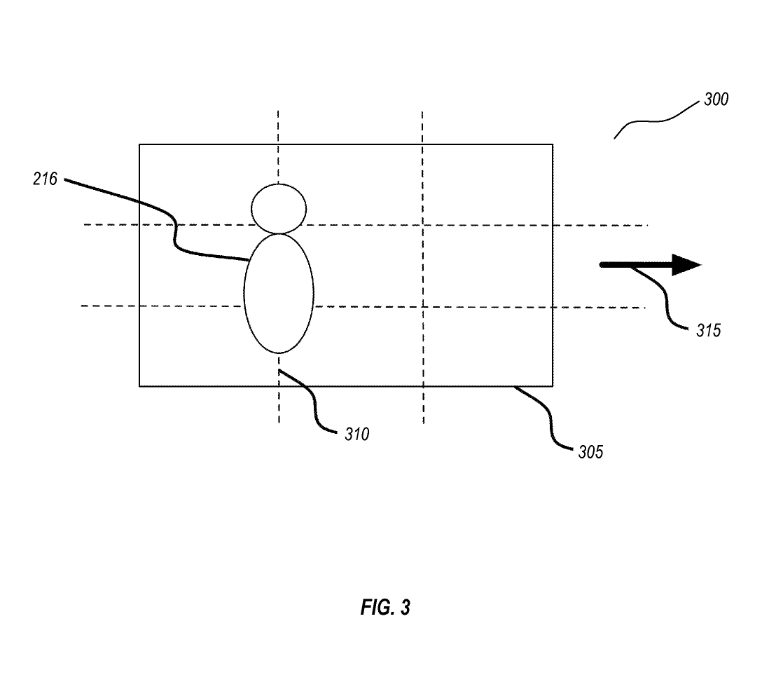

FIG. 3 is a non-limiting but stylized illustration 300 of a tracking object 216 being framed within a video frame 305. Cross-lines 310 divide the frame into vertical and horizontal thirds, as shown. The arrow 315 illustrates the direction in which the tracking object 216 is moving.

In at least one implementation, due to the direction of movement 315 of the tracking object 216, framing the tracking object 216 to the left of the screen may be desirable. By use of the processes of system 100 or 200 described above, a tracker may keep a tracking object 216 in the specific area or coordinate of the frame (relative to the cross-lines 310) or some other coordinates or areas, based upon configuration settings by a user.

In particular, configuration settings may be selected or entered or set by a user of a tracking system 200 via a UI System 220, or via another system such as the tracker 230 of system 200. A user may be able to thus specify where the face of the person (who is a tracking object 216) should be placed within the video frame 305, perhaps on intersecting cross-lines 310 or where the tracking object 216 as a whole may be framed. One will understand that the use of three cross-lines 310 is merely exemplary, and that fewer or more cross-lines 310 may be used.

In this context, or generally for tracking in system 200, a user may be able to specify the direction of travel of the tracking object 216, or that the system should use a direction of travel or curve or path derived automatically or otherwise by the pattern recognition & integration. The user may also be able, via a UI System 220, to specify a path or curve. There may be various ways that a user may define a path or curve of expected travel of a tracking object.

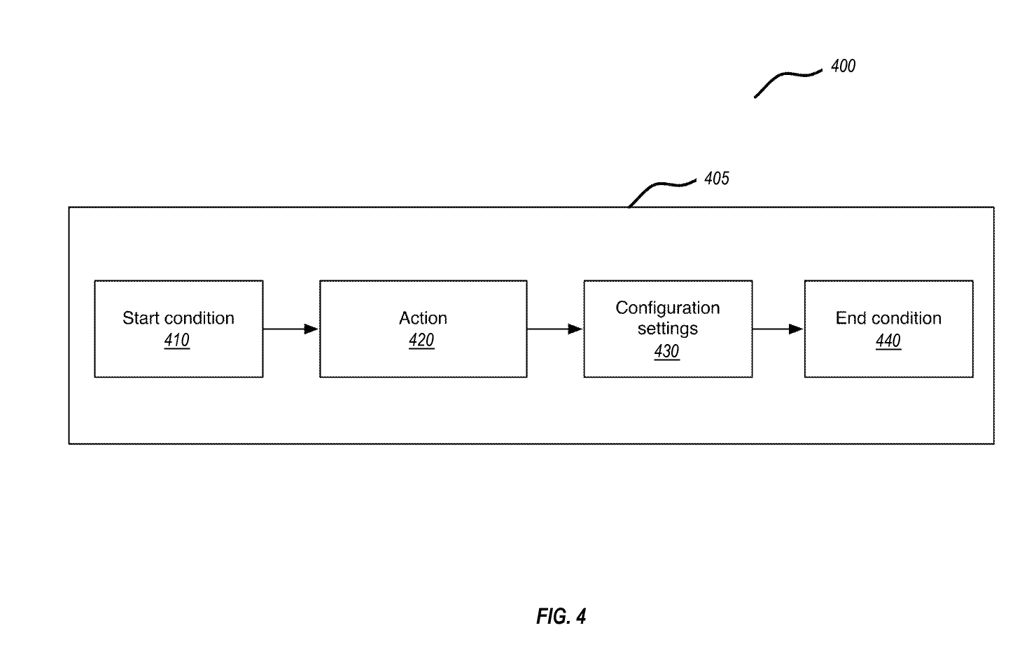

FIG. 4 is a depiction of a schematic diagram of an embodiment of a script 400. The most basic purpose of a script 400 may be to allow a user to “program” the behavior of his or her tracking device 230. For example, may be able to program a script comprising the components 405 shown. In particular, the script may comprise one or more specific start conditions 410, one or more actions 420, one or more configurations settings 430 that the actions 420 and other script components 405 are affected by, and one or more end conditions 440 for manipulating a mounting system 240, via a tracking device 230, sensitive to an emitter system 210, all relative to a fully interconnected grip system 250. In various implementations, a script does not require all components 405 (start condition 410, action 420, configuration settings 430, and end conditions 440) to be a valid or useful script.

For example, a script 400 may be created by a user to “program” the functioning of the tracker 230. Examples of script 400 actions may include the following: a tracker 230 watches for some start condition 410, and when found, executes a particular action 420 sensitive to some configuration settings 430 until some end condition 440 is reached. By way of a specific example, in a preferred embodiment of the invention, a script 400 may be formulated as follows: “If an emitterID 2 is NOT seen by tracking deviceID 55221” (start condition 410 component), “tilt & swivel along a predefined path” (action 420 component), “with a particular associated distance and speed” (configuration setting 430 component), “until 10 seconds have lapsed” (end condition 440 component).

In at least one embodiment, a script 400, or portion thereof, may conform to an XML file format (although it may be any data that might be represented in memory 2016 and processed with a processor). It may be created 542 by a user, shared 548 with other users, or otherwise duplicated 546 and edited 544 or managed 549 by one or more users. Scripts 400 may also represent users' “programming” of or more trackers 230 and one or more emitters 214 or 215 to do certain actions 420 under certain conditions 410, sensitive to some configuration settings 430, until some end-condition 440 is reached.

In at least one implementation, rather than require programming code and logic and syntax, a script 400 can be easily configured from options made available via a UI system 220 and UI app 224, or system 300. For example, means of creating 542 or selecting a script 400 from a script list 540 may be through a UI system 220 and/or a Computer System. A Computer System includes a PC, tablet, smartphone, or other device having a processor or similar and memory or similar or an FPGA or similar component. In at least one implementation, the UI system 220 can thus be considered a Computer System. A Computer System may or may not be interactive with other Computer Systems via Wi-Fi or Bluetooth or similar or Ethernet or cellular or similar technologies.

In at least one implementation, a script 400 may be represented by a number, an icon, a tab, a button, a list of multiple scripts, or other representation of a script 400. The script may be accessible via a user interface I/O subsystem 226 to the tracker's control subsystem 234, or to the emitter I/O subsystem 212 or emitter device 214 (212 and 214 are collectively sometimes called “emitter” 215). Thus it may be possible that the user, via a script 400, controls the control subsystem 234 and hence the tracker 230, or the emitter 215.

Similarly, the script 400 may control the mounting system 240 or a grip system 250 via the device I/O subsystem 246. Additionally, it may be possible for the mounting system 240 or a grip system 250, tracker 230 or emitter system 210, or parts or portions thereof, to affect in some way or degree the script 400 as well.

A script 400 may be encoded, decoded and fully integrated with software code. Software code, including a portion of which might be script 400 data or content, may be stored in memory and manipulation by a processor as a part of a Computer System, or other device of tracking system 200, including a memory devices and Computer System which may be a server or computer interconnected with the internet. Thus scripts 400 may be both saved and retrieved in some manner by and between different users within a tracking system 200.

A script 400, or a portion or representation thereof, may be displayed in a user interface main options menu, a script list, a select script portion, or a script manage portion. Within the UI application or app 224, a script list 540 may be displayed after a user selects a script 400 icon or other UI control representation within a user interface 310 of an application 224 running within a UI system 220.

A script 400 may be associated with one or more trackers 232 or other elements of one or more tracking devices 230, with one or more emitters 215 or other elements of one or more emitter systems 210, with one or more mounting systems 240 or elements thereof, or with grip systems 250 or elements thereof. In particular, the scripts could be associated with the components via a user interface application 224, including the tracking device list, an emitter list, or a script list.

In at least one implementation, emitters 215, trackers 230, mounting systems 240, and a grip systems 250 may all be fully responsive to or interactive with start conditions 410, actions 420, configuration settings 430, or end conditions 440 of any script 400. One will understand that there may be user-definable, and virtually limitless options relating to start conditions 410, actions 420, configuration settings 430, or end conditions 440. Users may select from existing options. Over time, additional options may be provided by programmers or power users, via firmware upgrades or the like, to other users. And thus the theoretical total possible scripts 400 that can be created from these options, may grow over time. Such upgrades may be facilitated for users. Finally, a script 400 need not have each component 405 to be considered a useful script 400. Nor must it interact with all subsystems of tracking system 200 to be considered a useful script 400.

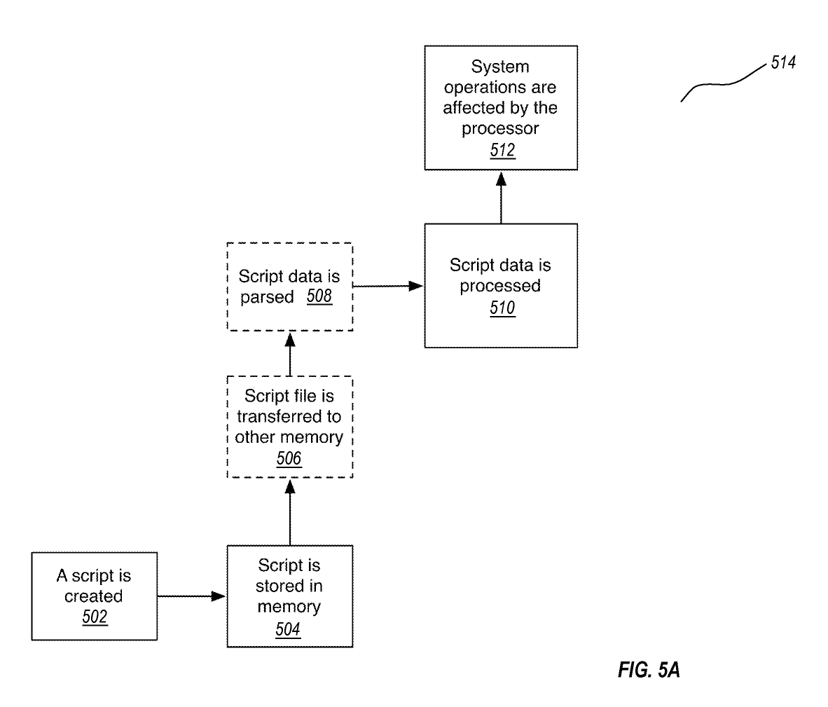

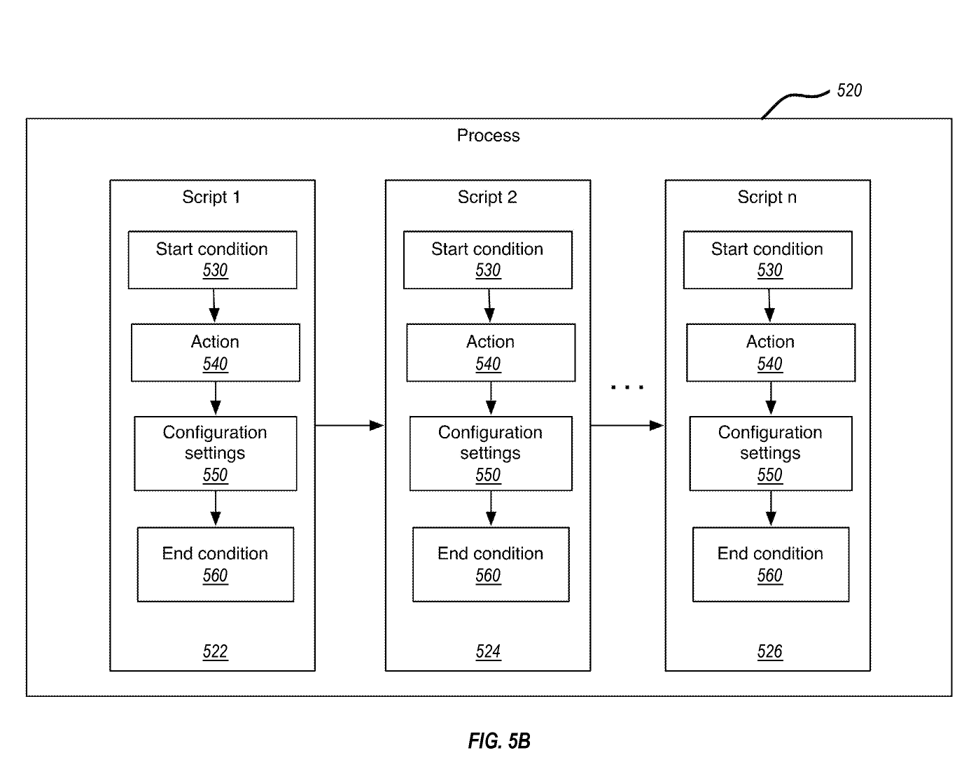

FIG. 5A is a method or process used within a tracking system 200 to create and use a script 400 in order to affect the functioning of system 200. In general, a script is created 502 by a user from options available for doing so within an app 224. That script is typically stored in memory 504 until it is later transferred 506 or parsed 508 and processed 510. Processing 510, in a preferred embodiment, includes a processor of tracker 230 processing data from the script 400 according to software commands or algorithms—all running within the tracker 230. Finally, the tracker 230 system operates 512 (tracks, tilts & swivels, etc.) as a result of this processing 510.

More specifically, a script can be created 502 by a user of the tracking system 200. A script may also be created by another means, provided that some or all of the data components 405 of a script 400 are somehow defined (for example, the tracker 230, or UI System 220, or emitter system 210 or mounting system 240 or a grip system 250 may create the script 400). For a script 400 to be created 502, a user will typically interact with an app 224 residing in a user interface device 222 like a smartphone or other Computer System. However, the script may be created in another manner altogether, and still qualify as a script 400 and be fully usable by system 514 and system 200.

For a script 400 to be created 502, data may be encoded into an XML or similar file, but it need not be thus or in any other manner encoded. As long as user preferences can be represented in a manner that system 514 or system 200 can employ or act upon those preferences, a script may be considered to have been created 502. In a preferred embodiment, once a script is created 502, it is stored 504 in memory. However, the script may be considered stored 502 in memory as soon as or as long as any data or user preferences that can be considered to be associated with a script 400 resides in memory within the tracking system 200.

In at least one embodiment, before a script 400 can be usefully employed by a tracker 230 or a tracking system 200, the script 400 is transferred 506 from a smartphone 222 or other Computer System to the tracking device 230 (from one memory location to another) so that it can be parsed 508, processed 510, and affect system operations 512 of the tracker 230 or other device of system 200. However, a script may be transferred 506 from one memory location (of any device in system 200) to any other memory location (of any device in system 200—including the same device). Similarly, a script may not be transferred 506 to another memory location at all, as may be the case if a script is created and executed on the same device of system 200.

Additionally, in at least one embodiment, script data is parsed 508, before it is processed 510 by a tracking system 230. Method 514, however, may not require either data or user preferences to be parsed 508. In addition, script data may be processed 510 by a processor within tracker 230, affecting system operations 512 including sensing, controlling, positioning (e.g., tilting & swiveling) and other processes associated with system 100 or system 200 (including previously-defined processes of knowing, sensing, plotting, saving, configuring, predicting, smoothing, or positioning).

FIG. 5B represents a process 520 or group of scripts 400, illustrated here as three scripts 400 labeled script 1 522, script 2 524, and script n 526. In at least one implementation, because an end condition 440 associated with any script 400 may trigger the starting of a new script 400, scripts can be strung together. When they are, they may be termed “processes” 520. A process may have one or many scripts 400 associated with it. Thus script n 526 represents as many additional scripts 400 as a user desires to associate or group into a process 520.

Both scripts 400 and processes 520 may be listed, created, edited, duplicated, shared, and managed by system 200 or app 224, or by other systems 220 or a Computer System or tracking system 200. Processes 520 may be associated with one or more emitter systems 210 or groups of emitter systems 210, tracking devices 230 or groups of tracking devices 230, mounting systems 240, or grip systems 250 or groups of mounting systems 240 or grip systems 250, UI systems 220 or groups of UI systems 220, or with devices or methods or subsystems associated with these, including a Computer System and its associated subsystems including memory and bus and networking (and related data storage and hubs).

By way of example, process 520 may comprise “If an emitterID 2 is NOT seen by tracking deviceID 55221, tilt & swivel along a predefined path, with a particular associated distance and speed, until 10 seconds have lapsed; then [new script 2 524], If an emitterID 2 [still] is NOT seen by tracking deviceID 55221, perform a “panorama” scanning or swiveling activity (as might be selected or defined by a user in activity list 522), with a particular associated speed, until emitterID 2 is seen by tracking deviceID 55221; and then [new script n 526] track emitterID 2. This example process 520 is made up of three scripts: the first script 400 tells its tracking device 230 to follow a defined path if it can no longer see its emitter 210 or 215; the second script 400 tells the tracking device 230 to swivel back and forth until it finally sees the emitter 210 or 215; the third script tells the tracking device 230 to follow the emitter 210 or 215. This process illustrates with new script n 526, that a script does not require all components 405 (start condition 410, configuration settings 430, and end conditions 440) possible within a script 400 to be employed by a script 400 (to still be useful).

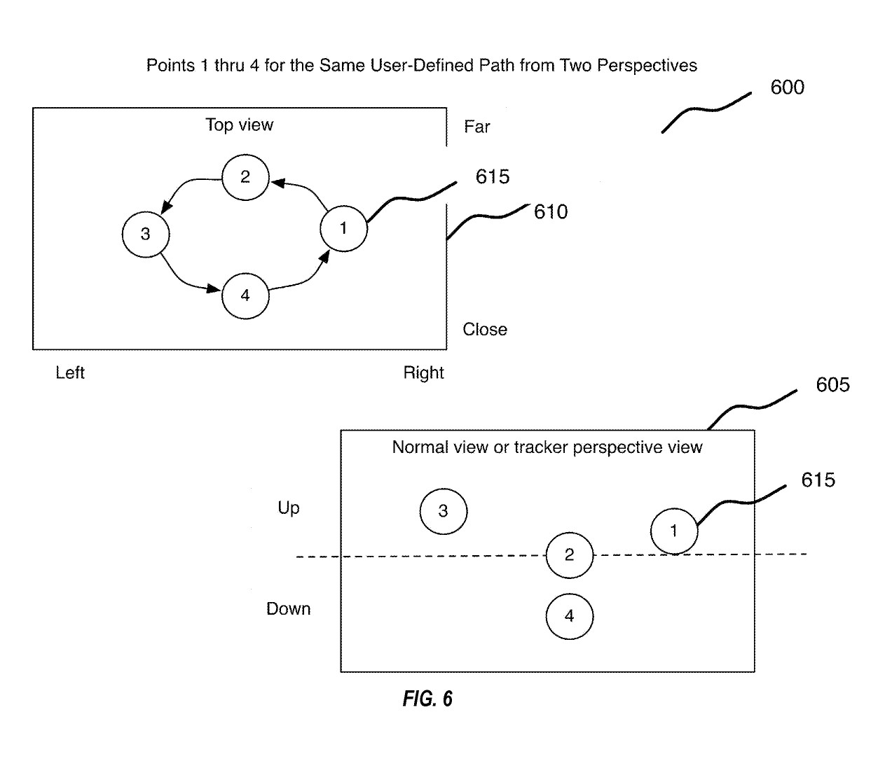

FIG. 6 is a non-limiting but stylized illustration 600 of elements of an expected path of a tracking object as it might be defined by a user from two perspectives 605 and 610 within a UI System 220. The path of a tracking object 216 may be defined by a user specifying one or more points 615 representing their placement in space, from a top view 610 perspective (as from a drone or quad copter) or a normal or tracker-view perspective 605. By defining multiple points (such as 1 thru 4 on view 610), a user can specify a general shape and path of travel.

Similarly, a user may be enabled to specify directions of travel 315 (shown in FIG. 3) between points 615 or for the diagram 600 or 610 or 605 as a whole. A user may also be enabled to specify speeds of travel between points or for the diagram 600 or 610 or 605 as a whole. A user may also be enabled to specify other configuration data like speeds and distances for points.

By defining paths of travel, and biasing of the framing of the framing object 216 or framing objects 216 (upon which may be one or more emitters 215) or a portion of the framing object(s) 216, the tracker 230 may be more predictive and smooth, and thus the video of the attached camera 242 may be more artistically affected.

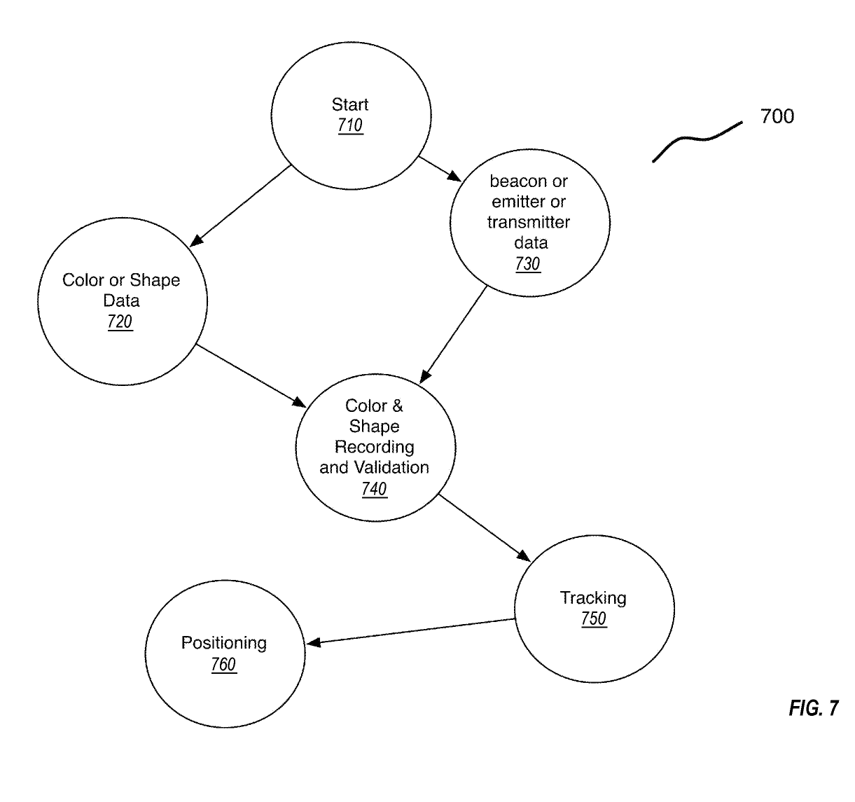

FIG. 7 depicts a block diagram of an implementation of a method 700 for integrating data from color & shape recognition 720 as well as from beacon or emitter data 730 and validation, and for integrating the results in order to improve tracking and positioning. For example, after the method starts 710, color or shape data 720 is obtained from analysis of an image from an image sensor within a sensory subsystem 232 of a tracker 230. Computer vision methods and algorithms for doing this are known in the art. Emitter or transmitter or beacon data 730 (including beacon position data) is also obtained by the sensory subsystem 232 and control subsystem 234 of a tracker 230.

If one or more emitters 215 or beacons 215 or transmitters 215 are associated with a tracking object 216, then the color or shape of the tracking object 216 may be marked “valid” and saved into memory by process step 740 for later retrieval and analysis. By this validating activity 740 a tracker 230 can store in memory growing number of shapes and colors or combinations of the two which are known to be identified with the emitter 215 and presumably the tracking object 216 on which the emitter is located.

This process 700 can be used to automatically “configure” a tracker 230 as a part of the system 200 process of “knowing” what to track. And it may be used to enable the tracker 230 to track even in situations where the emitter or beacon 730 data is unavailable, but the validated color or shape of the tracking object 216 are visible. Accordingly, in at least one implementation a tracking object 216 can be properly framed even when the emitter data is not available.

Again, method 700 allows that if emitter data 730 is temporarily or permanently unavailable, then color or shape data 720 that can be compared to previously saved and “validated” 720 color or shape data, in order to perform tracking 750 activities, and positioning 760 activities. Tracking 750 activities may include the following system 200 processes: knowing, sensing, plotting, saving, configuring, predicting, smoothing, and positioning—among others.

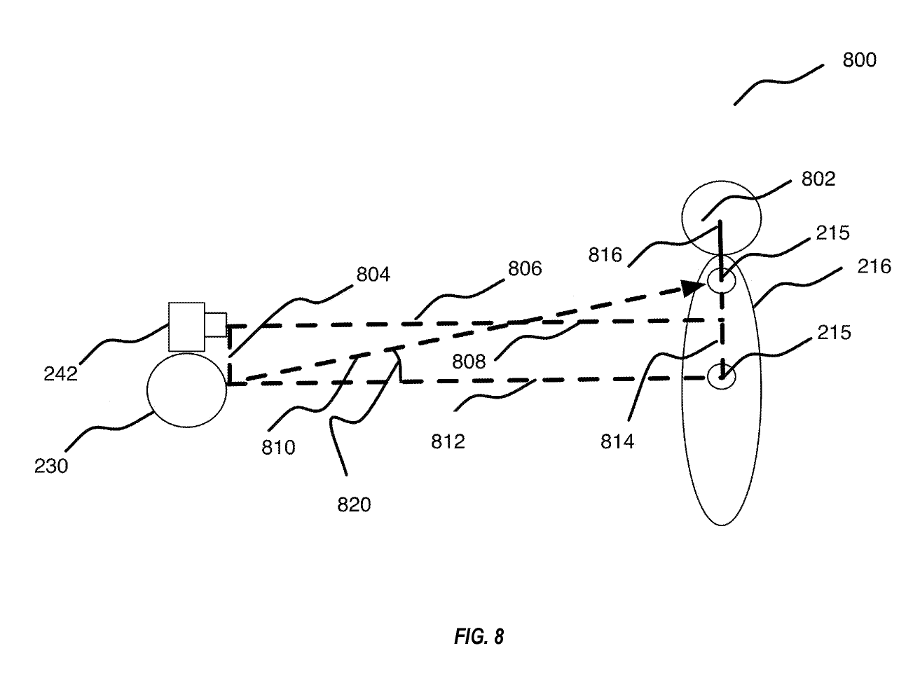

FIG. 8 depicts a stylized illustration of an implementation of tracking object 216 and two emitters 215 and a tracking device 230 and an attached camera 242—showing the trigonometric relationships between them—provided to enable a description of a means of improved framing by use of such data. The tracking object 216 is a rough figure of a person with a head or face 802 and two emitters 215 which are a known distance 814 apart from each other, and the top emitter 215 is a known distance 816 from the middle of the head or face 802.

The mounted device or camera 242 is mounted to the tracker 230 (above or below, depending upon the orientation of the user), where the lens of the camera 242 and the sensory subsystem 232 of the tracker 230 is a known distance 804 apart. The tracker 230 is a distance 812 from the bottom emitter 215, which can be calculated using basic trigonometry by knowing distance 814 and by assuming that line 812 and line 814 form a right triangle. The distance of line 810 from the sensory subsystem 232 to the top emitter 215 can also be calculated with basic trigonometry.

Because line 806 (from the camera 242 lens to the tracking object 216) is parallel with line 812, and because the distance from the top emitter 215 to the middle of the face 802 is known as 816, in at least one implementation, the tilting of the tracker 230 and the attached camera 242 can be biased to point at the face rather than distance 804 above the bottom emitter 215 on the tracking object 216. In particular, the necessary angle of tilt 820 can be calculated to enable the camera 242 to point at the face 802 of the person or tracking object 216.

This is a method for adjusting the tilting (or swiveling) of a tracking device in order to properly frame a tracking object or a portion of the tracking object (the face 802) as that tracking object 216 moves nearer or further away from the tracker all in order to record “desirably-framed” footage (footage of the face, rather than the “chest” of the person or tracking object 216) with the camera 242. Using this method, and attaching two or more emitters 215 at a known distance vertically apart, and by knowing a distance 816 from one of the emitters 215 to the “desired” portion of the tracking object 216 or person (such as the face 802) a user of a tracker 230 and attached camera 242 can automatically frame the “desired” portion of the tracking object or person 216 in the video recorded by camera 242. Benefits of this method include being able to more accurately frame a jersey or a helmet, feet or tires, or windows, or some other specific part of some tracking object 216.

When combined with color and shape data 720, including face shape data derived from 802 system 800 data can be even more helpful in framing a tracking object 216. In particular, in at least one implementation, the method described above can be used to identify the location of a target object's face. Facial recognition methods known in the art can then be applied to the face. The resulting data can then be stored and later used to target the face of the target object.

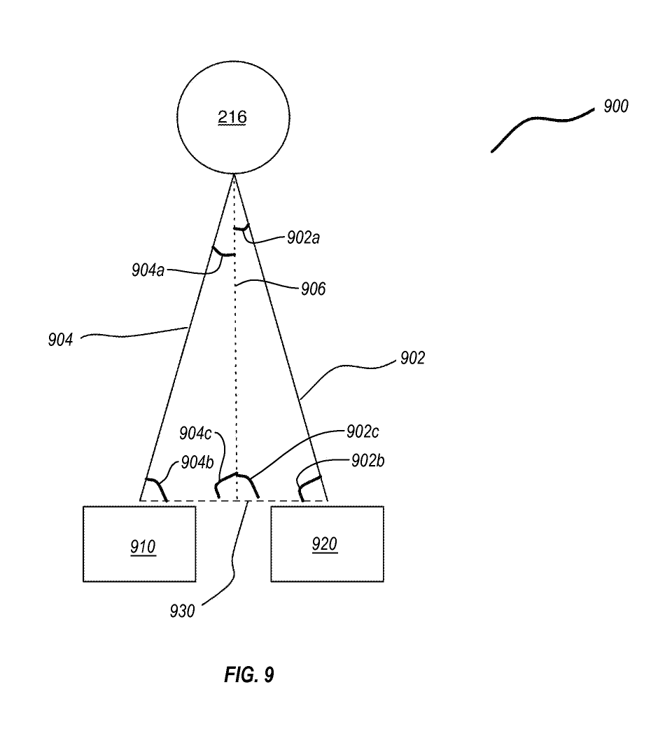

FIG. 9 depicts a schematic diagram of an implementation of two camera modules 910 and 920 found within a sensory subsystem 232 of a tracker 230, so that distance may be determined between the tracker 230 and the tracking object 216, using known trigonometric principles and formulas relating to parallax and optionally focus distance of the lenses. As used with regards to FIG. 9, the terms “tracking object” 216 and “emitter” 215 may be used interchangeably in this description of FIG. 8C.

The first lens subsystem 910 is located a distance 930 from the second lens subsystem 920. When both subsystems 910 and 920 are aimed 104 directly at the tracking object 216, the distance 904 represents the distance between the first lens subsystem 910 and the tracking object 216, and the distance 902 represents the distance between the second lens subsystem 920 to the tracking object 216.

Angle 904b and angle 902b represent the angles for camera subsystems 910 and 920 respectively, and how each camera subsystem must be oriented to point at the tracking object 216 from a top view perspective. Distance 906 is the distance to the tracking object from the midpoint between the camera subsystems 910 and 920. Angles 904c and 902c are the internal angles, which are right angles, when the tracking object 216 is equidistance to camera modules 910 and 920. Additionally, angles 904a and 902a can be solved by various trigonometric formulas by knowing other angles, or distances and angles in combination.

Using known trigonometric formulas, the distance to the tracking object 216 from the camera models 910 and 920 can be determined. Knowing the distance 906 from the midpoint between camera modules 910 and 920 of the tracker 230 to a tracking object 216, as well as angle 904b and angle 902b enables data calculations by the control subsystem 234 or another system or subsystem of system 200 to be able to provide data to the positioning subsystem 236 such that motors can aligned with the tracker 230 to point 104 at the tracking object 216.

Using known computer vision facial recognition techniques, and combining systems and methods of the present invention, including those relating to system 800 and system 200 and processes of 300, the face 802 of a tracking object 216 might be followed and properly framed at different distances away from the tracker 230. Furthermore, a lens of a mounted 242 camera device might be programmatically focused via automation tasks 405 of system 200.

Accordingly, in various implementations, the benefits to framing with a tracker and with two camera modules 2209 at a known distance 1906 apart are many. For example, a tracking object's distance 906 can be determined and tracking can be made more accurate with the resulting, calculated data, including angular data 902b and 904b. Additionally, framing of a tracking object 216 or a face 802 can be properly framed at different distances 906 from the tracker 230. Further, in at least one implementation, two cameras within the tracker 230 might at times provide optionally different benefits: a) both cameras used as described above to track using 3D parallax and trigonometric calculations, b) one camera may track while the other camera may record video, c) both cameras may record video (3D video) while tracking is being done simultaneously (via analyzing some frames for their content in order to do 3D parallax and trigonometric tracking, or other kinds of tracking including IR emitter tracking).

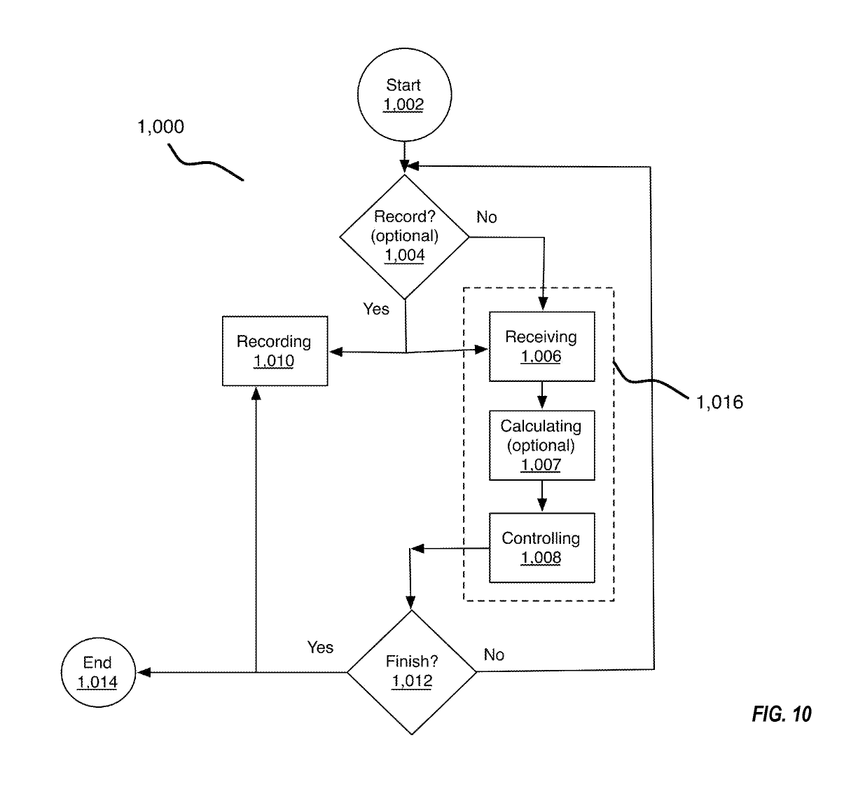

FIG. 10 is a non-limiting illustration or block diagram 1000 of a method for both tracking (1,006, 1,007, and 1,008 all optionally interconnected with and/or enabled by one or more processes of tracking system 100 or 200) and recording video 1,010 with or without a mounted device 242 which is a camera (but may be a light or microphone or other mounted device) or perhaps without a mounting system 240 at all.

Method 1,000 starts 1,002 by optionally identifying 1,004 if video should be recorded 1,004. This question may be satisfied by user input directly into the tracking device 230 or by pre-configured user input via use of a UI subsystem 220 or by some other means or subsystem of tracking system 200, including processes of system 200 or scripts running on UI application 224, or sensory input received by sensory subsystem 232 or by control subsystem 234 from any system or subsystem of 200.

If the user of system 200 configures 1,004 affirmatively (answers Yes), then recording of video 1,010 and receiving 1,006 (and tracking generally 1,016) may commence. In at least one implementation, a tracker 230 may always record video 1,010 and hence question 1,004 may be unnecessary. Receiving 1,006 may include the control subsystem 234 receiving data or images or signals from the sensory subsystem 232 or some other subsystem of system 200 in order to analyze or calculate 1,007, via a processor or FPGA or other electronic logic circuit or chip or module, and communicating to the positioning subsystem 236 where the tracker 230 motors should be moved or controlled 1,008 in order to keep the tracking object 216 or emitter 215 framed (or aimed at or pointed to 104).

In at least one implementation, the calculating 1,007 of data for controlling 1,008 the motors may be optional, as such calculations 1,007 may be done outside of the tracker 230 altogether, but effectively provided to the tracker 230 (receiving 1,006). In this and similar ways, calculating 1,007 may be optional even if a mounted device 242 is used by the tracker 230, and the mounted device 242 is a camera. Additionally, tracking 1,016 may be facilitated by one or more processes of system 100 or 200.

The process or method 1,000 may finish 1,012 when a user of system 200 or subsystem of system 200 either directly (using any subsystem of system 200, including the tracker 230) or indirectly (via configuring a subsystem of system 200, via a script of app 224 or otherwise) answered 1,012 affirmatively. In this case, the recording 1,010 and/or the tracking 1,016 may singly or together both end 1,014.

In various implementations, tracking 1,016 and recording 1,010 and other steps of system 1,000 may be affected by or affect other subsystems and methods and processes of system 200. Additionally, calculating 1,007 may be provided (to receiving 1,006 or to controlling 1,008) by an attached device 242 which may be a smartphone or other camera or other device (or a grip device 250) capable of both recording video and/or tracking faces or colors or shapes or RF signals or RF ID's or audio or GPS data, or altimeter data, or other sensory data. The smartphone 242 or other device 242 or 250 may be controlled by a user of system 200 using a UI device 222 and associated app 224.

A tracking system 200 or tracking device 230 may track a subject 216 or tracking object 216 (or emitter system 210 or subsystems thereof) automatically while aiming 104, 102 a mounted camera for recording video of the tracking object 216. In at least one implementation, however, the tracking system itself may contain a sensory subsystem 232 capable of recording and storing video with or without the assistance of the control subsystem 234 or positioning subsystem 236.

Accordingly, if a tracking system 200 or 230 could both automatically track 1,016 a subject 216 or 210 and record video 1,010 simultaneously (which could be viewed and otherwise used or enjoyed)—without the need of an attached camera 242 or mounted camera 242—the benefits would be clear to a user. In particular, the benefits would include less equipment to carry around, shorter setup time, convenience, redundant video coverage in the event that the mounted camera's video is not good or is not sufficient. Tracking 1,016 may include the aiming or pointing 104 of the tracker 230 at the tracking object 216 or emitter 215. Additionally, such a system 200 may mount a light 242 or microphone device 242 (or both) while itself 230 recording video 1,010 with the accompanying benefit of enhancing the audio or lighting of the video simultaneous to recording it.

In at least one implementation, video and audio recorded 1,010 by the tracker 230 may be made available, to other subsystems of tracking system 200. The video or images thereof or this audio or portions thereof may be used by mounting systems 240 to better record audio (in the case that the mounted device 242 is a microphone) or to light in better or different ways (as in the case when the mounted device 242 is a light). Using triangulation 900 or otherwise, multiple trackers 230 may share video or audio obtained by the tracker 230 (or otherwise), or data derived thereof via a control subsystem 234 or UI device 222 or other subsystem of system 200 or other computer or system outside of system 200 in order to affect the tracking 1,016 or recording 1,010 or triangulation 900 or distance finding 800 or pointing 104 or 102 of lights 242 or microphones 242 or cameras 242 of other trackers 230 of a system 200.

Thus trackers 230 may become affected or controlled 232 or receive data to be analyzed by 234 or otherwise via an FPGA or other electronic logic circuit or system, in order to affect the grip system 250 or mounting system 240 or UI system 220 or emitter system 215 or 210 with the following kinds of unique and valuable benefits: (1) to light one or more tracking objects 216 differently or better, (2) to record audio of a one or more tracking objects 216 differently or better, (3) to track 1,016 one or more tracking objects 216 differently or better, (4) to record video of one or more tracking objects 216 differently or better, (5) to communicate to and move a camera via a grip system 250 differently or better for one or more tracking devices 230 or tracking objects 216, and (6) triangulating 900 or adjusting 800 one or more trackers 230 in more accurate or responsive ways. In at least one embodiment of the tracking system 200, such benefits as described herein may accrue to system 200 with or without the tracking device 230 recording video or audio via its internal sensory subsystem 232.

Video recorded 1,010 by the tracker 230 may be made available, via the UI system 220 or other subsystems of system 200, to systems outside of tracking system 200. This may provide unique and powerful benefits of data that can be beneficial to users or others systems, including such data as this: (1) location of a tracking object 216, (2) speed of a tracking object 216, (3) acceleration of a tracking object 216, (4) orientation in 3D space including the facing of a tracking object 216, (5) light measurements associated with a tracking object 216, (6) sound or audio associated with a tracking object 216, (7) other sensory data associated with a tracking object 216 or associated emitter 215, (8) video associated with a tracking object 216.

In at last one implementation, the steps of system or method 1,000 may be controlled, initiated, or enabled or executed entirely or in part by the tracking device 232 or system 200. In concert with the foregoing, the UI system 220 or subsystems thereof, may assist or enable or configure the sensory subsystem 232 to initiate the process 1,002 or to decide to record video 1,004, or to perform a recording task 1,010 or not—or to assist with or perform or enable others steps of method 1000 or processes associated with system 100 or 200.

If a device 230 is recording still images or video, as well as tracking based upon what is in the images, then in at least one implementation the tracker's own view or frame can include both what a user wants to record as well as what is required by the tracker 230 to position 236 its motors. This can be achieved using commonly known computer-vision algorithms and methods which can be processed by a processor of system 200 (or FPGA or other logic circuit of system 200) in order to provide positioning subsystem 236 data for motor actuations, while the sensory subsystem 232 images or video can also be recorded to memory within system 200.

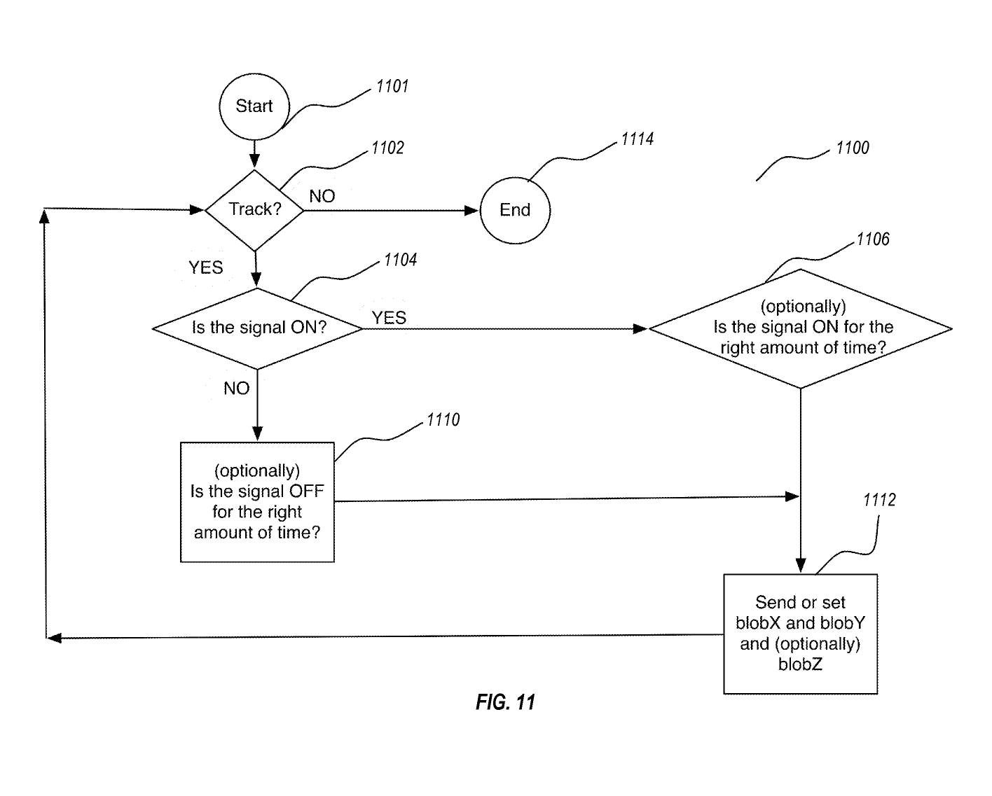

FIG. 11 depicts a flowchart of an implementation of a method for passing actuation data to a motor-positioning subsystem, based upon whether or not an emitter 215 signal pulses for a proper amount of time (and uniquely from most ambient light sources). More specifically, FIG. 11 is a non-limiting method 1100 for sending or setting the x, y (and optionally z) coordinates 1112 of the emitter 215 signal as seen by sensors (IR, RF, audio, etc.), based upon whether or not the signal is ON 1104, and (optionally) how long it is ON 1106, or whether the signal is OFF 1110, and (optionally) for how long it is OFF 1110, effective for achieving benefits of discontinuous signal tracking.

These x, y, and optionally z coordinates indicate where a detected signal is (or likely to be if currently in an off state). These coordinates 1112 can be sent to a positioning subsystem (236) in order for that subsystem to actuate motors in order to aim at an emitter 215. The question 1102 of whether to start 1101 tracking (or whether continue or stop 1114) may be answered by a user of the tracking system directly by interacting with the tracker 230, indirectly via data previously received via user interface system 220 or by some other subsystem or algorithm or logic of system 200.

Question 1102 may also be answered by the tracking system 200, or one or more subsystem thereof, including the tracker 230, via processing of data, which may include configuration settings originating from the user. Methods and processes of 100 and 200 may be employed in such automated or manual decisions 1102. In a preferred implementation, question 1104 of whether the signal is ON 1104 is generally made with access and knowledge of how long it was previously off or not seen (or not sensed). In the case that the signal is visible for the first time, the duration may not be known. But if the signal is on and has previously been on such that the duration of being OFF is known, or if otherwise the signal is known to have been off, then question 1104 may conclude both that the signal is ON and that the ON signal is a pulse. Thus the x, y, and optionally z coordinate of the emitter or transmitter cloud point of light or other signal may be sent or set 1112 to be used by the control subsystem 234 or positioning subsystem 236 (and may involve other steps or processes of system 100 or system 200.)

In at least one embodiment of the invention, if the signal is ON and has previously been on such that the duration of being OFF is known, then question 1104 can be answered YES by the tracker 230 (via software algorithms and processing of a microprocessor or logic analysis of an FPGA or the like), and then question 1106 can be answered: was the ON state 1708 duration for the expected amount of time (given that the emitter 215 on state and pulse frequency and pattern is known). If the previous questions are properly answered then the ON signal can be considered more confidently to have originated from the emitter 215, and the signal beacon or emitter's x and y and optionally z locations can be determined in order to aim 104 the tracker 230 at the beacon or emitter 215 or tracking object 216.

If the signal is OFF as determined by question 1104, the beacon or emitter's x and y and optionally z locations (as last known or as predicted by system 200 or by a Kalman filter or other means including “curve fitting” with quadratic or quantic splines) may be set or sent 1112 to the positioning subsystem 236 (where various processes of system 200 may also be employed) in order to aim 104 the tracker 230 at the beacon or emitter 215 or tracking object 216.

In at least one embodiment of the invention, if the signal is OFF as determined by question 1104, and if the duration of the signal's being off 1110 is found to be the same as the expected OFF duration (plus or minus some reasonable variance) via software algorithms and microprocessor analysis or other means, then the assumed or predicted position data can be sent 1112 to the control subsystem 234 or positioning subsystem 236 (either or both of which may involve various processes of tracking system 200) in order to aim 104 the tracker 230 at the beacon or emitter 215 or tracking object 216.

If the signal is ON for the right amount of time 1106, the tracker may send data 1112 to the positioning subsystem 236. Thus if a signal, which may be of the proper frequency of light or sound or radio waves, is not off the right duration, it may not be tracked. Thus tracker 230 may not be distracted by other signals in the tracking environment 100.

If the signal is OFF for the right amount of time 1110, the tracker may send data 1112 to the positioning subsystem 236. Thus if a signal, which may be of the proper frequency of light or sound or radio waves, is not off for the right duration, it may not be assumed or predicted to be in a particular location. And thus the tracker 230 may not be distracted by signals that do not turn OFF for the proper amount of time within the tracking environment 100. This tracking process or method may end 1114 when by direct or indirect user input or by system 200 input, the track question 1102 cannot be answered YES. Because a pulsing signal may surge with greater power in some circuits than if it were in an ON state continuously, the pulsing signal may be “seen” or “received” or sensed from a further distance away, and thus provide greater benefits of distance.

In at least one implementation, because a pulsing signal may require less power than a continuous signal, a pulsing signal provides benefits of being able to be in an ON state longer, or lasting longer on the same battery, or drawing less electricity than one ON continuously. While there are clear benefits of a discontinuous pulsing of a signal, there are also problems of discontinuity. For example, problems can include (1) response time, (2) choppiness or discontinuities of the positioning subsystem 236 (including motors) of the tracker 232.

In at least one implementation, these problems can be overcome as follows. First, response time or reaction time of a tracker 230 may be increased by enabling the emitter 215 and the sensory subsystem 232 to work at faster clock rates, such as a greater number of pulses per second from an IR emitter 215, or a greater number of frames per second from an image sensor 232 or a greater number of pulses of RF or audio signal 215 per second with a corresponding greater capacity to sense or receive 232 such signals.

Second, the choppiness or discontinuities of the positions received by the positioning subsystem 236 when sent data 1112 (to the control subsystem 234 or other subsystem of 200) with discontinuities may be overcome by smoothing of data via Kalman filters or the like by the control subsystem 234 or other subsystem of 200 such that smoothed data points are fed to the positioning subsystem 236 (some or all of which may be facilitated by processes of system 200).

By overcoming such problems, trackers 230 that can use discontinuous pulses or signals from an emitter 215 or emitters 215 can function responsively and without choppiness or motor response, and provide benefits.

Challenges for a tracker's tracking discontinuous light pulses using only a single sensory subsystem 236 or camera image sensor portion of the subsystem 236, may include reduced responsiveness and less continuous motor movements, which may both be overcome by employing Kalman filters or quantic or cubic splines, which help to predict future emitter 215 positions and smooth transitions between known positions and or predicted positions.

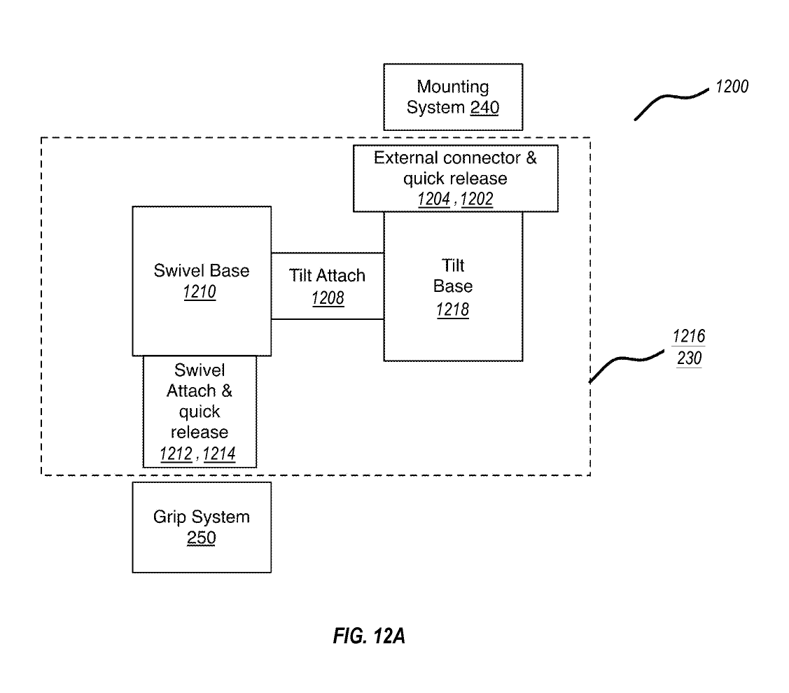

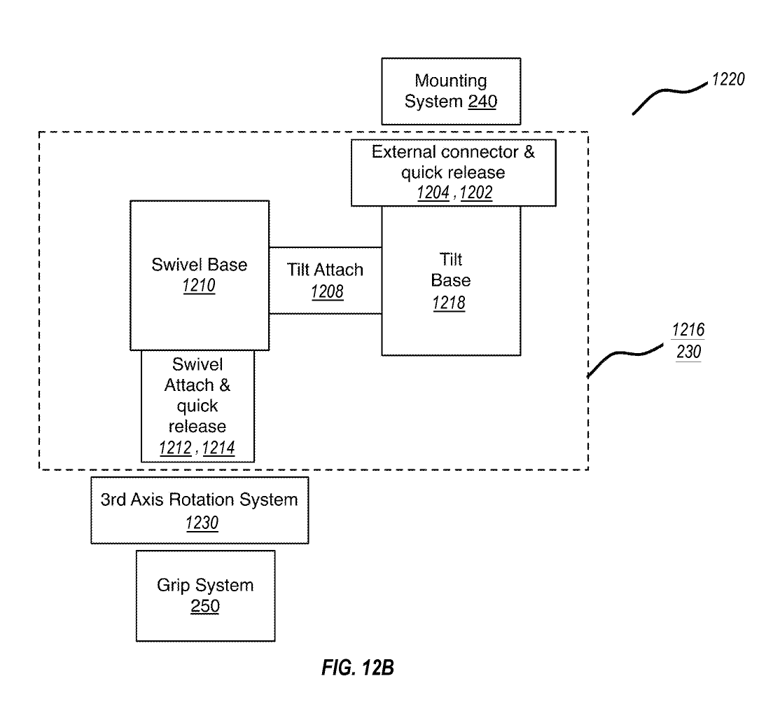

FIG. 12A depicts a block diagram of an implementation of a tracking device 230 or 1216 shown in 1200, integrated also with subsystems shown in 200, effective for describing the present invention. Additionally, diagram 1200 shows a mounting system 240 (found originally in system 200), and a grip system 250 (found originally in system 200). Attached to both (where the attachment for purposes of this invention is optional) is a tracking device 230 (found originally in system 200), which is also labeled as 1216 in diagram 1200.

Components of the tracker 230 or 1216, are shown as a swivel base 1210 which may include the gear system and motors and other components of a positioning subsystem 236. The swivel base 1210 may also affect the rotation on the tilt axis via a tilt attach 1208 bearing or other device. The tilt attach 1208 may be connected to the tilt base 1218 which rotates up and down in order to aim the mounting system 240 (via the external connector and quick release 1204 and 1202) and associated camera 242 at the tracking object.

The swivel base 1210 may also affect the rotation of the swivel attach & quick release components 1212 and 1214, which are typically attached to a grip system 250. Such rotation in this second axis or swivel axis enables the camera to be moved from side to side, in order the entire rest of the tracker 230 (and mounted camera 242, or other mounted device 242) from side to side.

FIG. 12B is a non-limiting block diagram 1220 of an embodiment of a tracking device 1216 or 230 and other components shown in FIG. 12A, with the addition of a 3rd Axis Rotation System 1230, effective for enabling the tracker 230 or 1216 to rotate along a 3rd axis of rotation, as would be necessary to correct a “Dutch Angle” or to generate or adjust a “Dutch Angle” as desired.

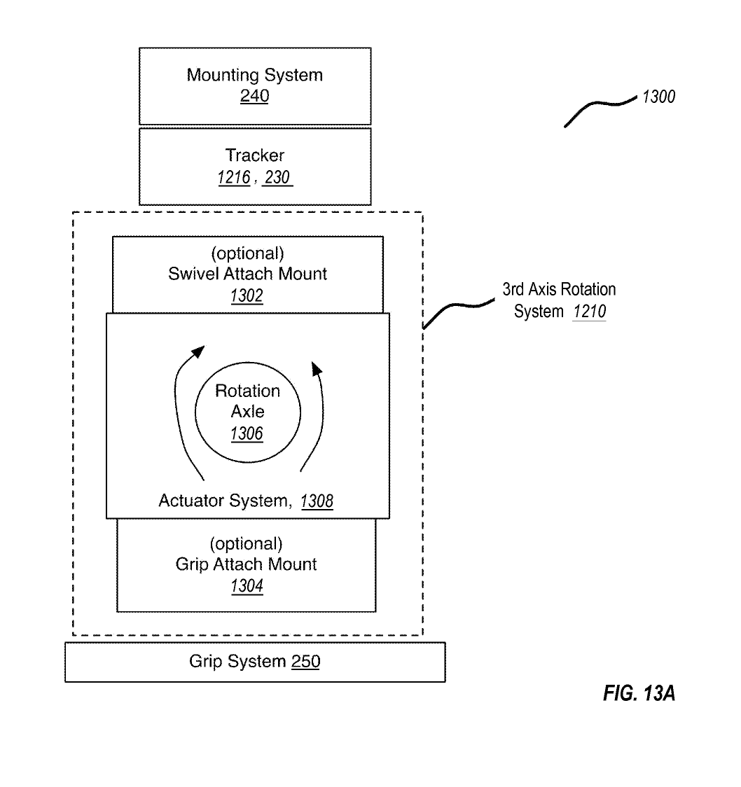

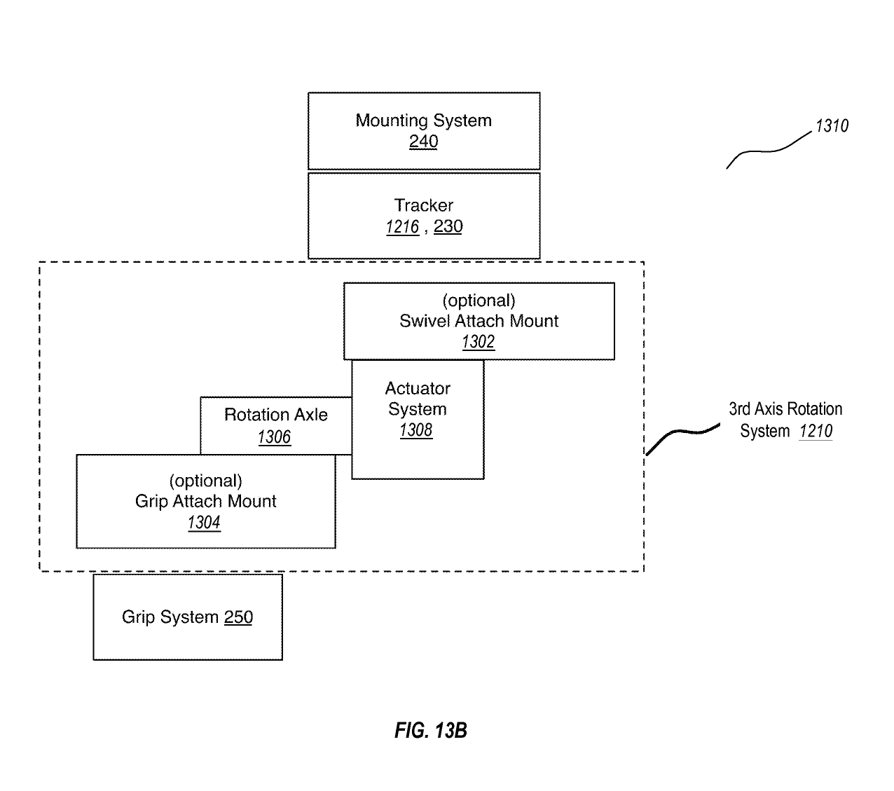

FIG. 13A depicts another block diagram of an embodiment of a tracking device, which may have the same components shown in FIG. 12A (1200), where the subcomponents of the 3rd axis rotation system 1300 is expanded to show more details. In particular, the 3rd axis rotation system 1300 includes the following subsystems: an actuator system 1308, a rotation axle 1306, and optional swivel attach mount 1302 and optional grip attach mount 1304.

The actuator system 1308 may include one or more motors or other actuators, as well as one or more axels or gear systems or similar systems which are affected by the actuators. The rotation axle 1306 is rotated or otherwise affected or moved by the actuator system 1308 and its associated gears or axels or other similar systems. Additionally, the actuator system 1308 or other component of the 3rd axis rotation system 1210, as well as any other subsystem of 1300 or 200, may include one or more gyroscopes, and/or accelerometers, and/or digital compasses, and/or digital levelers, or one or more other devices similar to one or more of these, which enable determination or sensing of rotation along a 3rd axis.

The 3rd axis rotation system 1210 may also include a sensory subsystem 232 or control subsystem 234 or positioning subsystem 236, or components thereof and functionality thereof, as well as components and functionality of other subsystems of 200 including but not limited to UI system 220. Thus as the 3rd axis rotation system 1210 senses that it may not be level with the ground (it may be contributing to a “Dutch Angle” for the associated mounting system 240), it may be able to compute angular adjustments so as to affect its own actuator system 1308 and rotation axle 1306 to change the rotation and bring itself into parallel with the ground plane.

The actuator system 1308 may thus receive sensory data from a sensory subsystem (which may be 232 or its own), and calculate angular and other data via a control subsystem (which might be 234 or its own) and affect its own actuators (or those of other subsystems of 200) via a positioning subsystem (which might be 236 or its own), in order to affect a rotation axle 1306 or other actuator-related device, in order to effect the rotation of the mounted tracker 1216 or 230 and mounting system 240 (if attached).

FIG. 13B is a non-limiting block diagram 1220 of an embodiment of a device, which may have the same components as shown in FIG. 12B, where 1310 is a side view, and 1300 is a front view. Within the 3rd axis rotation system 1210, an actuator system 1308 (already described in part related to 1300) may receive sensor data from a sensory subsystem like 232, and process that data according to software algorithms and code, via a processor (all data analysis may be performed via an FPGA or the like), which may reside within a control subsystem like 234.

System 1308 may affect a rotation axle 1306 (which may be associated with a positioning system like 236), which may in turn be attached or associated to an optional grip attach mount 1304 or grip system 250. By rotation from the rotation axle 1306 (which need not be an axle, but some form of actuator device) the tracker 1216 or 230 may thus rotate relative to a grip system 250. Thus a tracker 1216 or 230 and its associated mounting system 240 (if any) may be tilted, swiveled and rotated on a 3rd axis in order to track a tracking object 216 or emitter 215 while creating or correcting a “Dutch Angle” or otherwise affecting rotation along a 3rd axis.

Activities associated with FIGS. 12A-13B may all be interoperable with system 300 processes or related data, as well as interoperable in the same way with other devices and methods and processes and data and diagrams and illustrations associated with the present invention.

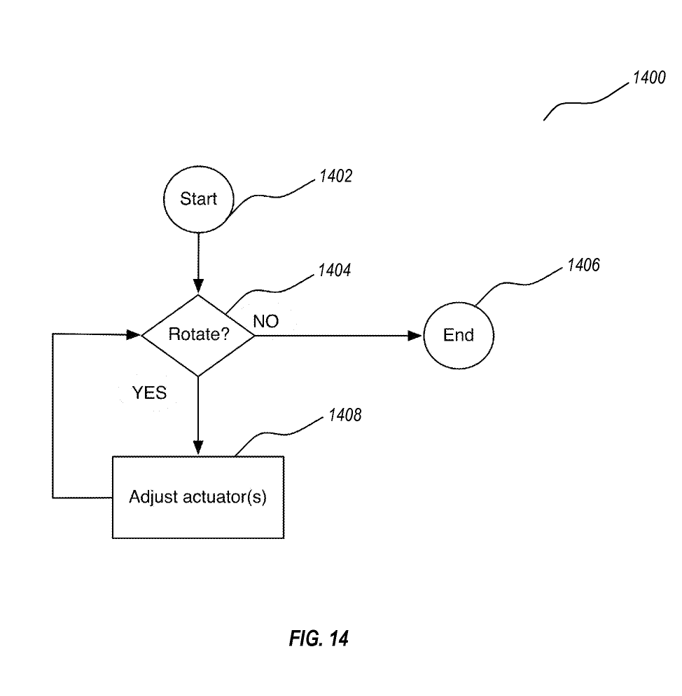

FIG. 14 depicts a flowchart for an implementation of a method for adjusting one or more actuators 1408 (associated with the Actuator System 1308 shown in FIGS. 13A and 13B), in order to rotate the tracking device 230 or 1216 in order to affect the video frame of the attached camera device 242 (or other device, if any) to be a “Dutch Angle” or to NOT be a “Dutch Angle,” or to otherwise affect its rotation along a 3rd axis of rotation. This process may trigger 1402 if a sensor or sensors (including encoders) identify that the tracker 230 or system 1210 or mounted device 242 or grip system 250 is no longer parallel to the ground or “horizontal” plane or angle.

The starting 1402 of the method or process for rotating a tracker 230 on a 3rd axis, may be from user intervention, or from user configuration, or determined by the 3rd axis rotation system 1210 or some other data and processing activities of system 200. The determination to rotate 1404 is basically the determination, based upon sensor data, if the tracker 230 or the system 1210 is not in a rotation state parallel with the ground.

This determination to rotate 1404 may involve analysis of sensor data. It may involve sensory data originating from system 1210 or elsewhere within the tracker 1216 or 230 or mounting system 240 or grip system 250 or elsewhere in system 200. It may also involve encoder data from system 1210 or elsewhere within the tracker 1216 or 230 or system 200.

Such a determination to rotate 1404 may involve processing via a microprocessor of data according to software algorithms and or code in memory (all of which may be replaced or supplemented by logic analysis of an FPGA or electronic circuitry, or the like). Rotating 1404 may include calculating the data required by the actuator system 1308 or 3rd axis rotation system 1210 to adjust actuators 1408 effective to rotate a tracker 230 or 1216 on a 3rd axis of rotation to be parallel with the ground or some other “horizontal” plane or angle.

Adjusting actuators 1408 may involve additional (or exclusive) analysis of data related to sensors or motors or encoders of system 200, including those of the actuator system 1208, and of system 1210, as well as the tracker 1216 or 230, and the grip system 250, and the mounting system 240, and other subsystems of 200 including the UI system 220.

This process ends 1406 when for whatever reason the system 1400 (or users or subsystems of 200) determines that rotation 1404 should no longer occur. In a preferred embodiment, this process ends when the sensor data indicates that the tracker 230 or system 1210 is parallel to the ground or other “horizontal” plane or angle—and thus no additional rotation 1404 is needed.

Again, this process may trigger or start 1402 if a sensor or sensor identify that the tracker 230 or system 1210 or mounted device 242 or grip system 250 is no longer parallel to the ground or “horizontal” plane or angle.

Accordingly, implementations of the present invention provide many distinct and novel features that provide significant benefits. For example, one of the benefits provided by this invention includes the framing of a subject or tracking object or emitter within an video frame in a manner preferred by a user. In other words, enabling a user to achieve predicting and positioning processes that result in video footage from mounted devices 242 that is more preferred by the user. A user may thus implement a “rule of thirds” principle of photography—or some other principle of framing—and in the process standardize his or her video clips to bias the tracker 230 sensitive to their own preferred principles.

Another of the benefits provided by this invention includes the need for a user to be able to “script” an activity to be performed by a tracker 230 or emitter 215 or mounted device 242 (or yet other elements of the tracking system). Such activity scripts 405 may have start conditions 410, device actions 420, configuration settings 430 to be used by one or more devices, and activity ending conditions 440 which may also initiate a second activity script in a process 520.

Such activity scripts might usefully be moved to and implemented within a second or more specified tracking devices 230 and/or emitters 215 and/or mounted devices 242 and other elements of the tracking system in order for the user to easily, and in a standardized manner, track in similar or identical ways from different points of view (each mounted camera 242 or device 242 occupying a different position in 3D space) within system 100 or 200 as desired by a user to achieve specific tracking or cinematic goals.

Another feature provided by this invention may include allowing paths of travel of the emitter 215 or tracking object 216 to be defined or represented graphically as shown in system 600. A top view 610, as from a drone's perspective, or a normal view 605 (as from the tracker's 230 perspective) may allow defining and showing of points representing positions over time of where the emitter 215 or tracking object 216 may be. Additionally, such systems 600 may include speed or velocity information of an emitter at different points along a path or curve of travel. The benefits of such user-defined paths and curves may include better tracker responsiveness, smoothness, and better processes of predicting and positioning.

Additionally, implementations of the present invention provide a tracking system that may both automatically track a subject and record video simultaneously. The benefits would be clear for a user: less equipment to carry around, shorter setup time, convenience, redundant video coverage in the event that the mounted camera's video is not good or is not sufficient.

An additional or alternative benefit may be that the tracking system could mount a light or microphone device (or both) rather than a camera—while itself recording video—with the accompanying benefit of enhancing the audio or lighting of the video simultaneous to recording it.

Additionally, implementations of the present invention provide beneficial use of discontinuous pulses. For example, benefits of using discontinuous rather than continuous signals can include the following: less distraction from non-pulsing signals (ambient light or signals NOT from emitters 215) in a tracking environment 100; less power usage; greater range of use (trackers 230 may be able to sense emitters 215 from further away because signal strength is temporarily stronger when pulsing).

Further, implementations of the present invention can provide beneficial and novel uses of validating tracking object information. For example, benefits of validating 702 tracking object's 216 color or shape data 704 with emitter data 702 include being able to track 300 and position 236-2 the tracker 230 even when the emitter data 702 may not be visible or sensed by the sensory subsystem 232.

Benefits of using two or more emitters 215 on one tracking object 216 can allow the tracker 230 to more properly frame a face 802 or other part of a tracking object 216 as the distance 812 between the two is known and closes or expands. Similarly, benefits of using two camera modules 910, 920 within a tracking device 230 as shown in 900 include a tracking object's distance 3 can be determined in more ways. Additionally, implementations of the present invention provide methods and systems for automatically adding and removing a “Dutch Angle” from video footage. As such, footage from the tracker 230 or attached device 242 may be more usable.

In the various implementations described herein, the 3rd Axis Rotation System 1210 may be embodied in several ways, including (1) within the tracker 230 or 9016 itself; (2) within a grip system 250 that is attached to the tracker. Similarly, the 3rd Axis Rotation System 1210 may be able to affect the angle of (1) the tracker 230 itself, and/or (2) the angle of the mounting system 240 or device, but no mounting system 240 may be required, and no grip system 250 may be required to implement a 3rd Axis Rotation System 1210 beneficially.

For example, if the mounted device 242 is a camera, and is embedded within the tracker 230, the 3rd Axis Rotation System 1210 is still anticipated to be able to adjust the video recorded by the tracker 230 and enjoyed by users, where the video may represent benefits of auto tilting, swiveling, and rotating on a 3rd axis (so as not to produce “Dutch Angles,” or so as to create or adjust “Dutch Angles.”)

For another example, the 3rd Axis Rotation System 1210 is built into a grip system 250, or independent both from a grip system 250 and from the tracker 230, an embodiment of it may none-the-less work effectively with the grip system 250 and with the tracker 230 in order to affect rotation on a tilt, swivel, and 3rd axis of rotation.

One will understand that a 3rd Axis Rotation System 1210 may also be beneficial even if the mounted device 242 is not a camera, but rather a light or microphone, or some other device.

As used herein, the modules, components, flowcharts, and box diagrams are provided for the sake of clarity and explanation. In various alternate implementations the modules, components, flow charts, and box diagrams, may be otherwise, combined, divided, named, described, and implemented, and still fall within the description and invention provided herein. Similarly, various components and modules may be otherwise combined to perform the same or different functions and still fall within this description and invention.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A system for tracking a cinematography target, the system using multiple components to identify and track the target, the system comprising:
an emitter configured to attach to a target and to emit a tracking signal, the emitter comprising:
an output module configured to emit the tracking signal, wherein the tracking signal comprises one or more identifiable signals;
a tracker configured to receive the tracking signal from the emitter and to track the emitter based upon the received tracking signal, the tracker comprising:
a receiver module configured to receive the tracking signal and to identify the one or more identifiable signals,
a control module configured to identify a location of the target and to position an audiovisual device to align with a target, and
a script execution processor configured to execute a user selected script, wherein the user selected script is selected from a set of respectively unique scripts and the user selected script determines one or more control module movements specific to tracking the emitter; and
a user interface device configured to receive commands from a user and communicate the commands to the tracker.

2. The system as recited in claim 1, wherein the user-selected script comprises a start condition, an action, a configuration setting, and an end condition.

3. The system as recited in claim 1, wherein the user-selected script comprises a command to introduce a specific bias to the framing of the emitter within a camera viewfinder.

4. The system as recited in claim 1, wherein the tracker comprises an integrated camera that is capable of both capturing images and providing tracking information to the control module.

5. The system as recited in claim 1, wherein the receiver module is configured to determined whether the received tracking signal modulates on and off at specific times and for pre-determined respective durations.

6. The system as recited in claim 1, wherein the receiver module is configured to identify one or more colors or shapes that are associated with an emitter and to store the identified information.

7. The system as recited in claim 1, further comprising a first emitter and a second emitter, wherein the first emitter and the second emitter are spaced a known, first distance apart from each other.

8. The system as recited in claim 7, wherein the control module is configured to interpolate the location of a face associated with target based a detected location of the first emitter and the second emitter.

9. The system as recited in claim 1, wherein the tracker is configured to automatically tilt and swivel to aim at the target, while at the same time rotating along a third axis in order to keep a tracker frame parallel to the ground.

10. The system as recited in claim 1, wherein the tracker is configured to automatically tilt and swivel to aim at the target, while at the same time rotating along a third axis in order to keep a tracker frame at a desired dutch angle relative to the ground.

11. A computer-implemented method at a tracking device for tracking a cinematography target that has been associated with an emitter, the method comprising:
receiving at the tracking device an indication to track a particular identifier, wherein the particular identifier is associated with the cinematography target;
identifying, using at least one tracker component, at least a direction associated with an origination point of an occurrence of the particular identifier;
executing a user selected script, wherein:
the user selected script is selected from a set of respectively unique scripts, and
the user selected script determines one or more tracking movement attributes specific to tracking the emitter
calculating, based upon the user selected script and the indication of at least a direction associated with an origination point of an occurrence of the particular tracking signal, a motor actuation sequence necessary to actuate a control component to track the object of interest in accordance with the user selected script; and
actuating at least one motor to track the object of interest in accordance with the calculated motor actuation sequence.

12. The computer-implemented method as recited in claim 11, further comprising:
identifying, using a camera associated with the tracking device, one or more shapes or colors associated with cinematography target; and
storing the identified one or more shapes or colors within memory.

13. The computer-implemented method as recited in claim 12, further comprising:
failing to receive the particular identifier associated with the cinematography target;
accessing, from memory, the one or more shapes or colors associated with the cinematography target;
detecting, with the camera, a direction associated an occurrence of the one or more shapes or colors associated with the cinematography target; and
calculating, based upon the user selected script and the detected direction associated with the occurrence of the one or more shapes or colors associated with the cinematography target, a motor actuation sequence necessary to actuate a control component to track the object of interest in accordance with the user selected script.

14. The computer-implemented method as recited in claim 11, further comprising sharing a script from a first tracking device to a second tracking device.

15. The computer-implemented method as recited in claim 14, wherein sharing a script comprises creating the script, storing the script in memory, transferring the script between memory modules, parsing of data from the script, processing the parsed script data, and actuating a different tracking device based upon the parsed script data.

16. The computer-implemented method as recited in claim 11, wherein the user selected script determines under what conditions to record and track the cinematography target.

17. The computer-implemented method as recited in claim 11, wherein the articular identifier is selected from a list of identifier, wherein each identifier within the list of identifiers is associated with a different emitter.

18. The computer-implemented method as recited in claim 11, further comprising:
identifying, using the at least one tracker component, a first direction associated with an origination point of an occurrence of a first particular identifier, which is associated with a first emitter;
identifying, using the at least one tracker component, a second direction associated with an origination point of an occurrence of a second particular identifier, which is associated with a second emitter;
accessing from memory an indication of a known distance between the first emitter and the second emitter; and
based upon the first direction, the second direction, and the known distance, calculating an expected face location for a human associated with both the first emitter and the second emitter.

19. The computer-implemented method as recited in claim 18, further comprising:
calculating, based upon the user selected script and the expected face location for the human associated with both the first emitter and the second emitter, a motor actuation sequence necessary to actuate a control component to track the expected face location; and
actuating at least one motor to track the expected face location.

20. A computer program product for use at a computer system, the computer program product comprising one or more computer storage media having stored thereon computer-executable instructions that, when executed at a processor, cause the computer system to perform a method for tracking a cinematography target that has been associated with an emitter, the method comprising:
receiving at the tracking device an indication to track a particular identifier, wherein the particular identifier is associated with the cinematography target;
identifying, using at least one tracker component, at least a direction associated with an origination point of an occurrence of the particular identifier;
executing a user selected script, wherein:
the user selected script is selected from a set of respectively unique scripts, and
the user selected script determines one or more tracking movement attributes specific to tracking the emitter
calculating, based upon the user selected script and the indication of at least a direction associated with an origination point of an occurrence of the particular tracking signal, a motor actuation sequence necessary to actuate a control component to track the object of interest in accordance with the user selected script; and
actuating at least one motor to track the object of interest in accordance with the calculated motor actuation sequence.
